(19) United States
(12) Patent Application Publication
(10) Pub. No.: US 2024/0059323 A1
(43) Pub. Date: Feb. 22, 2024

(54) DYNAMIC EMERGENCY DETECTION AND AUTOMATED RESPONSES

(71) Applicant: GM Cruise Holdings LLC, San Francisco, CA (US)

(72) Inventors: Alexander Willem Gerrese, San Francisco, CA (US); Jennifer Devar McKnew, Petaluma, CA (US); Spencer Lee James, Santa Clara, CA (US)

(21) Appl. No.: 17/890,517

(22) Filed: Aug. 18, 2022

(51) Int. Cl. B60W 60/00; B60W 40/08; H04W 4/90; H04W 4/46; H04W 4/02; B60R 25/24; B60R 25/01; B60Q 9/00

(52) U.S. Cl. CPC B60W 60/0016; B60W 40/08; H04W 4/90; H04W 4/46; H04W 4/023; B60R 25/24; B60R 25/01; B60Q 9/008; B60W 2540/043; B60W 2540/049; B60W 2540/221; B60W 2556/65

(57) ABSTRACT

Systems and techniques are provided for vehicle safety technologies. An example method can include detecting, based on sensor data captured by an autonomous vehicle (AV), an emergency event associated with the AV; and in response to detecting the emergency event, generating information about the emergency event based on the sensor data and sending, to an emergency responder, a wireless signal including a request for help from the emergency responder and the information about the emergency event; and based on a determination that the emergency responder is within a threshold proximity to the AV, providing additional data associated with the emergency event to the emergency responder and/or one or more devices associated with the emergency responder.

### TECHNICAL FIELD

The present disclosure generally relates to emergency detection and response systems for autonomous vehicles. For example, aspects of the present disclosure relate to techniques and systems for dynamic emergency detection and automated responses for vehicles and passengers of vehicles.

### BACKGROUND

An autonomous vehicle is a motorized vehicle that can navigate without a human driver. An exemplary autonomous vehicle can include various sensors, such as a camera sensor, a light detection and ranging (LIDAR) sensor, and a radio detection and ranging (RADAR) sensor, amongst others. The sensors collect data and measurements that the autonomous vehicle can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system. Typically, the sensors are mounted at specific locations on the autonomous vehicles.

### BRIEF DESCRIPTION OF THE DRAWINGS

Illustrative embodiments of the present application are described in detail below with reference to the following figures:

FIG. 1 is a diagram illustrating an example system environment that can be used to facilitate autonomous vehicle navigation and routing operations, in accordance with some examples of the present disclosure;

FIG. 2 is a diagram illustrating an example emergency event detection and automated response by an autonomous vehicle, in accordance with some examples of the present disclosure;

FIG. 3 is a diagram illustrating an example automated vehicle response to a detected emergency event, in accordance with some examples of the present disclosure;

FIG. 4 is a diagram illustrating an example action taken by an autonomous vehicle in response to a detected event, in accordance with some examples of the present disclosure;

FIG. 5 is a diagram illustrating example alerts generated by an autonomous vehicle when stopped due to an emergency event, in accordance with some examples of the present disclosure;

FIG. 6 is a flowchart illustrating an example process for detecting emergency vehicle events and automatically generating a response, in accordance with some examples of the present disclosure; and

FIG. 7 is a diagram illustrating an example system architecture for implementing certain aspects described herein.

### DETAILED DESCRIPTION

Certain aspects and embodiments of this disclosure are provided below. Some of these aspects and embodiments may be applied independently and some of them may be applied in combination as would be apparent to those of skill in the art. In the following description, for the purposes of explanation, specific details are set forth in order to provide a thorough understanding of embodiments of the application. However, it will be apparent that various embodiments may be practiced without these specific details. The figures and description are not intended to be restrictive.

The ensuing description provides exemplary embodiments only, and is not intended to limit the scope, applicability, or configuration of the disclosure. Rather, the ensuing description of the exemplary embodiments will provide those skilled in the art with an enabling description for implementing an exemplary embodiment. It should be understood that various changes may be made in the function and arrangement of elements without departing from the scope of the application as set forth in the appended claims.

One aspect of the present technology is the gathering and use of data available from various sources to improve quality and experience. The present disclosure contemplates that in some instances, this gathered data may include personal information. The present disclosure contemplates that the entities involved with such personal information respect and value privacy policies and practices.

As previously explained, autonomous vehicles (AVs) can include various sensors, such as a camera sensor, a light detection and ranging (LIDAR) sensor, a radio detection and ranging (RADAR) sensor, an audio sensor, amongst others, which the AVs can use to collect data and measurements that the AVs can use for operations such as navigation. The sensors can provide the data and measurements to an internal computing system of the autonomous vehicle, which can use the data and measurements to control a mechanical system of the autonomous vehicle, such as a vehicle propulsion system, a braking system, or a steering system.

Accidents and emergencies involving at least one vehicle represent a meaningful threat to road users and can be caused by a variety of reasons such as, for example, human error, road conditions, weather conditions, events, etc. Even seasoned or defensive drivers can experience vehicle collisions and associated risks. Numerous vehicle safety technologies can be implemented by autonomous vehicles and other vehicles to mitigate the risks and occurrences of collisions involving at least one vehicle. For example, a vehicle may implement a number of different sensors to detect objects and conditions in a driving environment and trigger actions (e.g., vehicle maneuvers, etc.) to avoid collisions, mitigate the risk of collisions, and/or mitigate the harm of collisions. While vehicle safety technologies can mitigate the risk that a vehicle may be involved in a collision, there are numerous potential risks from third parties (e.g., other vehicles, pedestrians, motorcyclists, etc.), animals, objects/obstacles, and/or occlusions that are difficult to avoid and/or mitigate.

Moreover, a rise in vehicle-related accidents and emergencies has resulted in an increased need for mass deployment of autonomous vehicles (AVs), which are generally safer than vehicles operated by human drivers. However, until all human drivers are replaced with AVs, there will inevitably be vehicle-related emergencies. To mitigate the risk of human drivers and even reduce the number of vehicle-related accidents and emergencies, fleets of AVs can be equipped with capabilities of self-diagnosis as well as capabilities for responding to emergencies. Such AVs can reduce various types of accidents and problems. One example problem often experienced by road users is the bystander effect. To illustrate, when an accident occurs, even if many people are present and able to call emergency services or provide immediate help, individuals often do nothing in anticipation that someone else will take on such responsibility, leading to poor response times and inconsistent access to emergency care.

Another example problem often experienced by road users and emergency responders is limited vehicle access. For example, if a passenger in a vehicle is incapacitated, nearby individuals and emergency responders trying to help may be unable to gain access to the vehicle and/or the passenger, leading to unnecessary damage such as windows and/or doors broken by individuals attempting to gain access to the passenger in order to help, as well as increased danger to the passenger inside of the vehicle. The lack of passenger communication is another problem that can exacerbate emergency situations and increase the danger to passengers involved in an accident/emergency.

For example, passengers involved in an emergency situation often have little to no information about what is happening outside of the passenger's vehicle, including whether someone has called for help or, if help has been called, how far away emergency responders might be to the scene. Moreover, the passengers involved in the emergency situation may not have a way to communicate with responders on their way to the scene, and thus may be unable to provide the responders relevant information about the emergency or otherwise receive helpful information from responders trying to reach the scene. In addition, if the driver of a vehicle involved in an emergency is incapacitated, the driver may be unable to maneuver the vehicle to a safe location/position, which can be dangerous to the driver and other road users if the vehicle is located in certain parts of the road (e.g., the middle of the road, a transited area of the road, etc.) and exposed to other vehicles or if the vehicle is in a place of low visibility, which can cause other vehicles to collide with the exposed vehicle.

In many cases, emergency responders may lack relevant context information that could otherwise help the emergency responders provide assistance or avoid additional emergencies (e.g., collisions, etc.). Indeed, when emergency responders arrive on the scene, they often have little to no context information, which can increase the amount of valuable time the emergency responders spend to help or diagnose the emergency. As a result, emergency responders often provide help and diagnosis based on incomplete information relevant to the emergency and their response.

Described herein are systems, apparatuses, processes (also referred to as methods), and computer-readable media (collectively referred to as “systems and techniques”) for dynamic emergency detection and automated responses in emergency situations. In some examples, the systems and techniques described herein can enable AVs to detect when they have encountered (e.g., experience, have entered, are involved in, etc.) a degraded state (also referred to herein as an emergency event) such as, for example and without limitation, an accident, a system or component malfunction, a medical/health event or emergency, an error state, an inoperable state, an event having a threshold risk of danger, a collision, a critical and/or urgent condition and/or situation, a crash, etc.

Moreover, the AVs implementing the systems and techniques described herein can determine how to respond to the situation (e.g., the degraded state and/or a situation associated with the degraded state) based on one or more factors (e.g., one or more environmental factors, contextual factors, operational and/or functional factors, safety factors, emergency factors, factors related to the degraded state, etc.), and respond to the situation accordingly. In some cases, if there are third parties (e.g., emergency responders, nearby individuals, remote assistance operators, etc.) involved in (e.g., providing assistance to a passenger(s) of the AV, affected by the degraded state and/or a situation associated with the degraded state, party to a situation associated with the degraded state, etc.) the degraded state and/or a situation associated with the degraded state, the AVs can provide the third parties relevant information to help the third parties respond to the situation.

An AV can provide such information to the third parties before the third parties arrive at the scene where the AV is located (e.g., and thus where the situation associated with the degraded state is located), while the third parties are en route to the scene where the AV is located, while the third parties are at the scene where the AV is located, and/or after the third parties and/or the AV leave/leaves the scene. Non-limiting examples of information that the AV can provide third parties in response to detecting a degraded state can include contextual information (e.g., information indicating what happened, how the degraded state occurred, details describing the degraded state, scene information, environment information, user information, details about one or more associated events, emergency information, risk information, property damage information, information about associated injuries, timing information, vehicle information, etc.), instructions to facilitate emergency responder interactions with potentially injured passengers, information for accessing the AV and/or a passenger(s) in the AV, information about the AV, sensor data captured by the AV (e.g., sensor data captured by the AV before the degraded situation, during the degraded situation, after the degraded situation, before emergency responders arrive at a scene of the AV, while emergency responders are en route to the scene of the AV, and/or after emergency responders arrive at the scene of the AV), user information, insurance information, vehicle and/or user preferences, contact information, captured metrics, status updates, message notifications, user profile information, scene information, security information, historical information, collected information, recordings, and/or any other information.

In some cases, sensor data captured by the AV and provided to third parties can include, for example and without limitation, data from an image sensor, a LIDAR sensor, a RADAR sensor, a pressure sensor, a smoke detector, an odor sensor, a door sensor (e.g., a sensor that can detect open and/or closed door state of one or more doors of the AV), an inertial measurement unit (IMU), a seat belt sensor, a weight sensor, an airbag sensor, an interior AV cabin sensor(s) (e.g., an interior camera, LIDAR, microphone, weight sensor, pressure sensor, a door sensor, an inertial sensor, a brake sensor, a friction sensor, an oximeter, a pulse or heart rate sensor (e.g., a pulse or heart rate sensor on a steering wheel or another portion of the AV, a smoke detector, an odor sensor, a light sensor, a global positioning system device, and/or any other type of sensor and/or combination thereof), a light sensor, a depth or time-of-flight sensor, a thermal camera sensor, a friction sensor, a weight sensor, a global positioning system (GPS) device, a light sensor (e.g., an ambient light sensor, an infrared sensor, etc.), an audio sensor (e.g., a microphone, a Sound Navigation and Ranging (SONAR) system, an ultrasonic sensor, etc.), an engine sensor, a temperature sensor, a speedometer, a tachometer, an odometer, an altimeter, a tilt sensor, an impact sensor, a seat occupancy sensor, a tire pressure sensor, a rain sensor, a camera sensor, and/or any other sensor and/or combination thereof.

In some examples, a user of the AV can approve the sharing of private user information in association with a degraded state (and/or associated situation) such as, for example and without limitation, health/medical data associated with the user, emergency contact information, user statistics, recorded image/video data, recorded audio, treatment preferences, historical user information, user activity information, demographics information, information about a state/condition of the user, and/or any other information.

As previously noted, in some examples, the AV can automatically detect that the AV (and/or a passenger(s) of the AV) is in a degraded state. The degraded state can include any state that prevents the AV from continuing or safely continuing a trip (e.g., from completing a trip) and/or for which the AV and/or a passenger(s) of the AV may need assistance. For example, a degraded state can include an accident involving the AV, a malfunction of the AV (e.g., of a software of the AV, a hardware of the AV, a mechanical system of the AV, an electrical system of the AV, a component of the AV, etc.), a dangerous condition of the AV, an error of the AV, a health/medical condition of a passenger(s) of the AV, an intoxicated and/or incapacitated state of a passenger(s) of the AV, an emergency involving the AV and/or a passenger of the AV, an inoperable state of the AV, a dangerous event in the AV and/or a scene associated with the AV, a critical and/or urgent condition and/or situation, any other degraded state, and/or any combination of degraded states and/or associated conditions and/or events.

In some examples, the AV can detect a degraded state when it detects damage to one or more sensors of the AV used to operate the AV and/or provide certain AV functionalities. For example, the AV can detect a degraded state in response to detecting a physical contact by one or more sensors of the AV with one or more foreign objects, a misalignment of one or more sensors of the AV, an occlusion affecting measurements and/or a visibility of one or more sensors of the AV, temperature shifts exceeding a threshold or a threshold change (e.g., which can affect an operation of the AV and/or one or more sensors of the AV), moisture damage to one or more components of the AV (e.g., one or more sensors, one or more hardware systems, one or more mechanical systems, etc.), a malfunction of one or more components of the AV, an error generated by the AV and/or one or more components of the AV, a condition of the AV, damage to the AV, an impact to the AV, an accident involving the AV, a health/medical event or condition of one or more passengers of the AV, etc.

In some cases, the AV can detect a degraded state based on image data (e.g., video, still images, etc.) captured by one or more image/camera sensors of the AV. For example, the AV can detect a degraded state based on a video and/or image(s) captured by an image/camera sensor of the AV which depicts the degraded state. In some examples, the AV can additionally or alternatively use audio data captured by one or more audio sensors of the AV to detect the degraded state. For example, an audio sensor(s) of the AV can listen for certain sounds that may indicate a degraded state such as for example and without limitation, noises having a sound level that exceeds a threshold (e.g., loud noises such as noises caused by an explosion or an impact between objects), abnormal sounds (e.g., sounds having below a threshold frequency of occurring, sounds having below a threshold probability of occurring, sounds that differ from certain predetermined sounds, sounds associated with a mechanical and/or electrical problem of one or more components of the AV, etc.), human sounds (e.g., keyword utterances, speech and/or specific phrases indicative of a degraded state, screams, certain types of human noises, etc.). In some cases, the AV can capture such sounds via one or more microphones on the AV. In some examples, the AV can implement a speech recognition algorithm and/or a sound detection and/or recognition algorithm to detect and/or recognize such sounds.

In some examples, the AV can additionally or alternatively use sensor data indicating vehicle damage to detect the degraded state. For example, the AV can use data from one or more sensors (e.g., one or more microphones, image sensors, impact sensors, LIDARs, pressure sensors, weight sensors, airbag sensors, inertial sensors, etc.) to detect damage to the AV such as, for example, a damaged/broken window, a flat tire, an airbag deployment, an impact to one or more regions of the AV, damage to one or more systems of the AV (e.g., a sensor, a braking system, an operating system, a mechanical system, a software system, a hardware system, a navigation system, a tire, a battery, an electrical system, etc.), etc. In some cases, the AV can additionally or alternatively use sensor data indicating a dangerous condition to detect the degraded state. For example, the AV can use data from an odor sensor(s) to detect certain odors indicative of a degraded state (e.g., odor from a leakage (e.g., a leaked fluid or gas, etc.), a chemical odor, a burning odor (e.g., odor from burning of a material), etc.), data from a smoke sensor/detector which can indicate fire/smoke and thus a degraded state, data from an inertial sensor indicating a threshold degree of deceleration which can indicate a degraded state such as a crash, data from an impact sensor indicating a degraded state such as a crash, etc.

In some cases, the AV can additionally or alternatively use service data to detect a degraded state. For example, the AV can use data about an operation of the AV to detect a degraded state. To illustrate, the AV can use data indicating that the AV is unable to complete a trip or safely complete a trip to determine a degraded state. Such data can include, for example and without limitation, data indicating a software error and/or malfunction, an error or crash of a computer of the AV, a malfunction of a mechanical system of the AV, a malfunction of a battery of the AV, data indicating an inability of the AV to operate, crash data, log data, data indicative of a problem with one or more sensor systems of the AV, a malfunction of an electrical system of the AV, etc.

In some cases, the AV can additionally or alternatively use service reports to detect a degraded state. For example, the AV can receive reports from nearby AVs indicating a certain event such as, for example, a behavior or event that deviates from a set of expected or predetermined behaviors/events (e.g., unexpected driving or behaviors of the AV, an event that is not expected to occur or that has a threshold level of abnormality, etc.), a dangerous activity/event (e.g., erratic driving, driving with one or more inoperable components of the AV are inoperable or damaged, driving while dragging an object, animal, or person, etc.

Moreover, the AV can additionally or alternatively use data from rider reports to detect a degraded state. For example, the AV can receive a passenger-generated signal indicating that something is wrong with the passenger and/or the AV. In some cases, the AV can additionally or alternatively use data about a passenger or a passenger condition to detect a degraded state. To illustrate, the AV can use sensor data to determine that a passenger is incapacitated or is experiencing a particular degraded condition/event (e.g., a health emergency, intoxicated, sleeping, incoherent, etc.) in order to detect the degraded state.

For example, the AV can use data from one or more camera sensors to detect closed eyes of a passenger that is sleeping or falling asleep, data from one or more sensors (e.g., a camera sensor, a LIDAR, an IMU, a weight sensor of a seat, etc.) to detect a certain body position of a passenger which can indicate that the passenger is experiencing a degraded condition (e.g., sleeping, unconscious, intoxicated, hurt, etc.), data from one or more audio and/or image sensors to determine that a passenger of the AV is unresponsive to prompts, data from one or more odor sensors indicating a presence of odors from drugs and/or alcohol, an image sensor to detect an eye gaze of a passenger that indicates that the passenger is distracted or otherwise in a degraded condition (e.g., intoxicated, sleeping, incoherent, etc.), an inertial sensor to detect a velocity of a passenger movement in the AV indicative of a degraded condition of the passenger, a seat belt sensor to determine if a passenger of the AV fell or experienced an impact, a suspension of the AV (and/or associated sensors) to determine that a passenger of the AV caused a detected jolt/impact by hitting a portion of the AV or falling over a portion of the AV (e.g., as opposed to a jolt/impact of the AV caused by a bump in the road), etc.

The systems and techniques described herein can enable the AV to respond to a degraded state detected by the AV. The AV can respond to the degraded state before third parties (e.g., emergency responders, etc.) are en route to the scene of the AV, while the third parties are en route to the scene of the AV, while the third parties are at the scene of the AV, and/or any combination thereof. In some examples, the AV can respond to the degraded state based on one or more factors such as, for example and without limitation, one or more characteristics of the degraded state, a location of the AV and/or an event associated with the degraded state, a type of damage and/or injuries resulting from the degraded state, a risk associated with the degraded state (e.g., a risk of damage, a risk of injuries, a danger of a collision or another emergency, etc.), a severity of the degraded state, a degree of imminence of a risk associated with the degraded state, a type of degraded state and/or associated risk(s)/danger(s), a state of the AV, an environment and/or scene associated with the degraded state, a condition of one or more passengers of the AV, a condition of one or more people in a scene associated with the degraded state, a connectivity and/or communication capabilities/conditions of the AV, a weather condition, traffic conditions, characteristics of a scene associated with the degraded state, one or more events, and/or any other factors.

For example, if the AV determines that the AV is blocking traffic or otherwise in a dangerous position, the AV can be configured to pull over to a safer location (e.g., away from incoming traffic, etc.). As another example, the AV response can depend on the severity of damage and/or injuries resulting from the degraded state. To illustrate, if the severity of damage to the AV and/or injuries to a passenger(s) of the AV is/are below a threshold (e.g., low severity, not life threatening, etc.), the AV may contact the passenger(s) of the AV and automatically perform one or more actions (e.g., next steps, etc.) or allow the passenger(s) to handle next steps. On the other hand, if the severity of damage to the AV and/or injuries to a passenger(s) of the AV is/are above a threshold (e.g., high severity, life threatening, a threshold amount of damage to the AV or other vehicles, etc.), the AV can contact emergency responders (e.g., firefighters, an ambulance, police, etc.) and/or a remote assistance (RA) system and/or person(s).

In some cases, the AV may respond by attempting to initiate communications between an RA system or person(s) and a passenger of the AV. If the passenger is responsive, the RA system or person(s) can gather from the passenger information about the passenger and/or the degraded state, determine a state of the passenger and/or the AV, provide instructions to the passenger, provide other type of assistance, and/or provide and/or gather any other information and/or communications. In some cases, if the AV is unable to initiate communications between the RA system or person(s) and the passenger, the AV can attempt to contact the passenger using audio output via one or more AV speakers, visual data presented to the passenger using one or more displays of the AV, light emitted by one or more lighting systems of the AV (e.g., flashing lights, etc.), vibrations generated by one or more components of the AV (e.g., by a steering wheel, a seat, etc.), data captured by one or more microphones and/or camera sensors to detect a response by the passenger, and/or any other data and/or combinations thereof. In some examples, if the AV is unable to obtain a response from the passenger and/or communicate with the passenger, the AV can contact a third party such as emergency responders.

In some cases, the response of the AV can depend on the degree of danger and/or how imminent danger is estimated to be as a result of the degraded state. For example, if the AV determines that the likelihood of immediate danger to the AV and/or one or more persons (e.g., a passenger, a pedestrian, a rider of another vehicle, etc.) is below a threshold (e.g., is low), the AV can coordinate a response with the passenger and/or an RA system or person(s). On the other hand, if the AV determines that the likelihood of immediate danger to the AV and/or one or more persons (e.g., a passenger, a pedestrian, a rider of another vehicle, etc.) is above a threshold (e.g., is high), the AV can contact emergency responders and/or deploy emergency evacuation procedures. For example, if the AV determines that the likelihood of immediate danger to the AV and/or one or more persons is above the threshold, the AV can unlock and open doors automatically to allow the passenger to evacuate the AV, turn off a battery of the AV to reduce a risk of fire/explosion, output audio and/or visual instructions for a passenger to evacuate the AV, engage a braking system of the AV, etc.

In some cases, the response of the AV to a degraded state can be at least partially based on user preferences. For example, in some cases, if a passenger of the AV has set an emergency contact in a user profile available to the AV or a configuration of the AV, the AV can notify the emergency contact of the situation and/or request help from the emergency contact. In some examples, the AV can establish communications with emergency responders alerted of the situation and/or en route to provide assistance. To illustrate, the AV can use one or more cameras on the AV, one or more speakers on the AV, one or more microphones on the AV, one or more displays on the AV, and/or any other devices to establish communications between the passenger of the AV and one or more third parties such as, for example, an RA person, emergency responders (e.g., en route, at the scene, or both while en route and at the scene), etc. The communications established between the passenger and one or more third parties (e.g., an RA person, emergency responders, etc.) can help establish context (e.g., can allow the passenger and third parties to exchange contextual information and any other information), build trust, ensure that the passenger knows what to expect and/or what to do, help the passenger, etc.

In some cases, the AV can detect the presence of first responders securely and communicate with the passenger(s) of the AV. For example, the AV can identify when an emergency vehicle (EMV) is nearby (e.g., within a threshold distance) based on sound recorded by one or more microphones on the AV and/or image data (e.g., video, still images, etc.) recorded by one or more camera sensors on the AV. In some examples, the sound of an EMV and/or a pattern of sounds of the EMV (e.g., volume, frequency, etc.) can allow the AV to infer a proximity of the EMV to the AV and/or whether the EMV is stationary or moving. In some examples, the AV can use data from one or more sensors (e.g., a camera sensor, a LIDAR, a microphone, etc.) to confirm that an EMV is nearby and/or a position of the EMV (which can imply that the EMV is there for a specific AV and/or emergency situation).

For security and/or to determine a help status, the AV can confirm that a person approaching the AV is an emergency responder. In some examples, the AV can use image data from a camera sensor and an image recognition algorithm to identify an official uniform of an approaching responder, a badge of the approaching responder, etc. In some cases, the AV can additionally or alternatively use voice recognition to identify the approaching responder. In some examples, the AV can provide an access code to emergency responders to provide the emergency responders access to the AV (e.g., to allow the emergency responders to open a door and ingress the AV) and/or to allow the emergency responders to authenticate themselves (e.g., so the AV and/or the passenger of the AV can determine that an approaching person is an emergency responder and does not represent a risk to the AV and/or the passenger). In some cases, the access code generated by the AV can be configured to expire after a certain amount of time in order to revoke future access to the AV using the access code.

In some cases, the AV can gather GPS tracking data to track when a particular EMV and/or emergency responder is dispatched for a situation and/or track the EMV and/or emergency responder while the EMV and/or emergency responder is/are en route to the scene of the AV. For example, the AV can receive GPS tracking information from the EMV and/or the emergency responder and provide an estimated time of arrival (ETA) of the EMV and/or emergency responder to the passenger and/or an RA system or person for increased transparency and status information. In some cases, if a passenger is able to, the passenger can unlock and open one or more doors of the AV to emergency responders or provide a verbal authorization to an RA system or person to remotely open one or more doors of the AV to the emergency responders. In some examples, the AV can communicate information about the situation to emergency responders (and/or an RA system or person) and recommend actions to emergency responders to save time and resources. Since the AV has access to local data (e.g., data from vehicle hardware) and backend data, the AV can provide third parties a more complete picture of the situation and/or recommend actions to human responders.

Moreover, the AV can have access to real time (or near real time) data (e.g., vehicle status information, passenger status information, external environment conditions, location information, contextual information, etc.) as well as historical information from sensors of the AV. The data from AV sensors can act like an airplane “black box” that allows third parties to “rewind the tape” on events during the situation and/or that led up to the situation. This type of contextual information can help first responders provide assistance and save time in providing assistance as the first responders do not have to perform redundant diagnosis with incomplete information. Moreover, this type of contextual information can allow the first responders to fill in contextual gaps (e.g., passenger A has a neck injury due to the angle at which the airbag deployed during a collision and needs to be given additional care when handled).

In some cases, the AV can provide information from a passenger's profile to facilitate care for that passenger. For example, first responders can learn the passenger's name from the passenger's profile to allow the first responders to address the passenger directly, creating a sense of trust during interactions, while also enabling the first responders to obtain relevant medical records and/or insurance information associated with the passenger. In some examples, the first responders can use the passenger's profile to discover accessibility needs of the passenger (e.g., whether the passenger has a disability such as a hearing disability, an eyesight disability, a language barrier, etc.) to allow the first responders to tailor their response to the needs of the passenger. The AV can communicate this information with first responders in various ways depending on the situation and/or other factors. For example, the AV can communicate this information with first responders using in-car audio, speech by an RA representative output by the AV, etc. In some cases, the AV can include an integrated dashboard that displays relevant information about a situation and actionable insights so emergency responders can learn about the situation while the emergency responders are preparing to leave to the scene, have left to the scene and are in transit, are arriving on the scene, are at the scene, and/or any combination thereof.

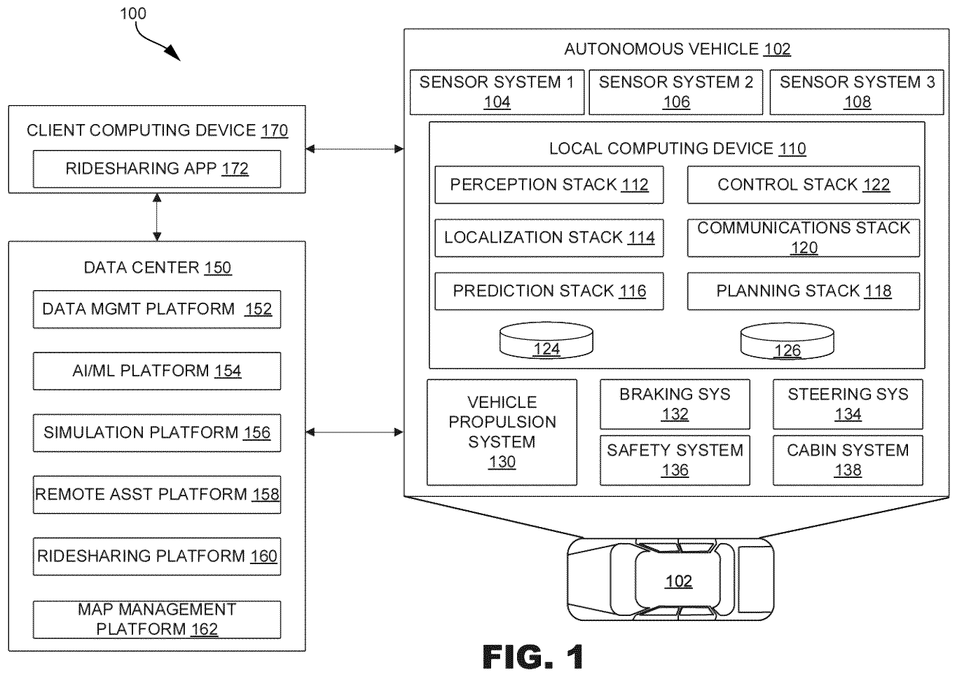

Examples of the systems and techniques described herein are illustrated in FIG. 1 through FIG. 7 and described below.

FIG. 1 is a diagram illustrating an example autonomous vehicle (AV) environment 100, according to some examples of the present disclosure. One of ordinary skill in the art will understand that, for the AV management system 100 and any system discussed in the present disclosure, there can be additional or fewer components in similar or alternative configurations. The illustrations and examples provided in the present disclosure are for conciseness and clarity. Other examples may include different numbers and/or types of elements, but one of ordinary skill the art will appreciate that such variations do not depart from the scope of the present disclosure.

In this example, the AV management system 100 includes an AV 102, a data center 150, and a client computing device 170. The AV 102, the data center 150, and the client computing device 170 can communicate with one another over one or more networks (not shown), such as a public network (e.g., the Internet, an Infrastructure as a Service (IaaS) network, a Platform as a Service (PaaS) network, a Software as a Service (SaaS) network, other Cloud Service Provider (CSP) network, etc.), a private network (e.g., a Local Area Network (LAN), a private cloud, a Virtual Private Network (VPN), etc.), and/or a hybrid network (e.g., a multi-cloud or hybrid cloud network, etc.).

The AV 102 can navigate roadways without a human driver based on sensor signals generated by sensor systems 104, 106, and 108. The sensor systems 104-108 can include one or more types of sensors and can be arranged about the AV 102. For instance, the sensor systems 104-108 can include Inertial Measurement Units (IMUs), cameras (e.g., still image cameras, video cameras, etc.), light sensors (e.g., LIDAR systems, ambient light sensors, infrared sensors, etc.), RADAR systems, GPS receivers, audio sensors (e.g., microphones, Sound Navigation and Ranging (SONAR) systems, ultrasonic sensors, etc.), engine sensors, speedometers, tachometers, odometers, altimeters, tilt sensors, impact sensors, airbag sensors, seat occupancy sensors, open/closed door sensors, tire pressure sensors, rain sensors, and so forth. For example, the sensor system 104 can be a camera system, the sensor system 106 can be a LIDAR system, and the sensor system 108 can be a RADAR system. Other examples may include any other number and type of sensors.

The AV 102 can also include several mechanical systems that can be used to maneuver or operate the AV 102. For instance, the mechanical systems can include a vehicle propulsion system 130, a braking system 132, a steering system 134, a safety system 136, and a cabin system 138, among other systems. The vehicle propulsion system 130 can include an electric motor, an internal combustion engine, or both. The braking system 132 can include an engine brake, brake pads, actuators, and/or any other suitable componentry configured to assist in decelerating the AV 102. The steering system 134 can include suitable componentry configured to control the direction of movement of the AV 102 during navigation. The safety system 136 can include lights and signal indicators, a parking brake, airbags, and so forth. The cabin system 138 can include cabin temperature control systems, in-cabin entertainment systems, and so forth. In some examples, the AV 102 might not include human driver actuators (e.g., steering wheel, handbrake, foot brake pedal, foot accelerator pedal, turn signal lever, window wipers, etc.) for controlling the AV 102. Instead, the cabin system 138 can include one or more client interfaces (e.g., Graphical User Interfaces (GUIs), Voice User Interfaces (VUIs), etc.) for controlling certain aspects of the mechanical systems 130-138.

The AV 102 can include a local computing device 110 that is in communication with the sensor systems 104-108, the mechanical systems 130-138, the data center 150, and/or the client computing device 170, among other systems. The local computing device 110 can include one or more processors and memory, including instructions that can be executed by the one or more processors. The instructions can make up one or more software stacks or components responsible for controlling the AV 102; communicating with the data center 150, the client computing device 170, and other systems; receiving inputs from riders, passengers, and other entities within the AV's environment; logging metrics collected by the sensor systems 104-108; and so forth. In this example, the local computing device 110 includes a perception stack 112, a mapping and localization stack 114, a prediction stack 116, a planning stack 118, a communications stack 120, a control stack 122, an AV operational database 124, and an HD geospatial database 126, among other stacks and systems.

The perception stack 112 can enable the AV 102 to “see” (e.g., via cameras, LIDAR sensors, infrared sensors, etc.), “hear” (e.g., via microphones, ultrasonic sensors, RADAR, etc.), and “feel” (e.g., pressure sensors, force sensors, impact sensors, etc.) its environment using information from the sensor systems 104-108, the mapping and localization stack 114, the HD geospatial database 126, other components of the AV, and/or other data sources (e.g., the data center 150, the client computing device 170, third party data sources, etc.). The perception stack 112 can detect and classify objects and determine their current locations, speeds, directions, and the like. In addition, the perception stack 112 can determine the free space around the AV 102 (e.g., to maintain a safe distance from other objects, change lanes, park the AV, etc.). The perception stack 112 can identify environmental uncertainties, such as where to look for moving objects, flag areas that may be obscured or blocked from view, and so forth. In some examples, an output of the prediction stack can be a bounding area around a perceived object that can be associated with a semantic label that identifies the type of object that is within the bounding area, the kinematic of the object (information about its movement), a tracked path of the object, and a description of the pose of the object (its orientation or heading, etc.).

The mapping and localization stack 114 can determine the AV's position and orientation (pose) using different methods from multiple systems (e.g., GPS, IMUS, cameras, LIDAR, RADAR, ultrasonic sensors, the HD geospatial database 126, etc.). For example, in some cases, the AV 102 can compare sensor data captured in real-time by the sensor systems 104-108 to data in the HD geospatial database 126 to determine its precise (e.g., accurate to the order of a few centimeters or less) position and orientation. The AV 102 can focus its search based on sensor data from one or more first sensor systems (e.g., GPS) by matching sensor data from one or more second sensor systems (e.g., LIDAR). If the mapping and localization information from one system is unavailable, the AV 102 can use mapping and localization information from a redundant system and/or from remote data sources.

The prediction stack 116 can receive information from the localization stack 114 and objects identified by the perception stack 112 and predict a future path for the objects. In some examples, the prediction stack 116 can output several likely paths that an object is predicted to take along with a probability associated with each path. For each predicted path, the prediction stack 116 can also output a range of points along the path corresponding to a predicted location of the object along the path at future time intervals along with an expected error value for each of the points that indicates a probabilistic deviation from that point.

The planning stack 118 can determine how to maneuver or operate the AV 102 safely and efficiently in its environment. For example, the planning stack 118 can receive the location, speed, and direction of the AV 102, geospatial data, data regarding objects sharing the road with the AV 102 (e.g., pedestrians, bicycles, vehicles, ambulances, buses, cable cars, trains, traffic lights, lanes, road markings, etc.) or certain events occurring during a trip (e.g., emergency vehicle blaring a siren, intersections, occluded areas, street closures for construction or street repairs, double-parked cars, etc.), traffic rules and other safety standards or practices for the road, user input, and other relevant data for directing the AV 102 from one point to another and outputs from the perception stack 112, localization stack 114, and prediction stack 116. The planning stack 118 can determine multiple sets of one or more mechanical operations that the AV 102 can perform (e.g., go straight at a specified rate of acceleration, including maintaining the same speed or decelerating; turn on the left blinker, decelerate if the AV is above a threshold range for turning, and turn left; turn on the right blinker, accelerate if the AV is stopped or below the threshold range for turning, and turn right; decelerate until completely stopped and reverse; etc.), and select the best one to meet changing road conditions and events. If something unexpected happens, the planning stack 118 can select from multiple backup plans to carry out. For example, while preparing to change lanes to turn right at an intersection, another vehicle may aggressively cut into the destination lane, making the lane change unsafe. The planning stack 118 could have already determined an alternative plan for such an event. Upon its occurrence, it could help direct the AV 102 to go around the block instead of blocking a current lane while waiting for an opening to change lanes.

The control stack 122 can manage the operation of the vehicle propulsion system 130, the braking system 132, the steering system 134, the safety system 136, and the cabin system 138. The control stack 122 can receive sensor signals from the sensor systems 104-108 as well as communicate with other stacks or components of the local computing device 110 or a remote system (e.g., the data center 150) to effectuate operation of the AV 102. For example, the control stack 122 can implement the final path or actions from the multiple paths or actions provided by the planning stack 118. This can involve turning the routes and decisions from the planning stack 118 into commands for the actuators that control the AV's steering, throttle, brake, and drive unit.

The communications stack 120 can transmit and receive signals between the various stacks and other components of the AV 102 and between the AV 102, the data center 150, the client computing device 170, and other remote systems. The communications stack 120 can enable the local computing device 110 to exchange information remotely over a network, such as through an antenna array or interface that can provide a metropolitan WIFI network connection, a mobile or cellular network connection (e.g., Third Generation (3G), Fourth Generation (4G), Long-Term Evolution (LTE), 5th Generation (5G), etc.), and/or other wireless network connection (e.g., License Assisted Access (LAA), Citizens Broadband Radio Service (CBRS), MULTEFIRE, etc.). The communications stack 120 can also facilitate the local exchange of information, such as through a wired connection (e.g., a user's mobile computing device docked in an in-car docking station or connected via Universal Serial Bus (USB), etc.) or a local wireless connection (e.g., Wireless Local Area Network (WLAN), Bluetooth®, infrared, etc.).

The HD geospatial database 126 can store HD maps and related data of the streets upon which the AV 102 travels. In some examples, the HD maps and related data can comprise multiple layers, such as an areas layer, a lanes and boundaries layer, an intersections layer, a traffic controls layer, and so forth. The areas layer can include geospatial information indicating geographic areas that are drivable (e.g., roads, parking areas, shoulders, etc.) or not drivable (e.g., medians, sidewalks, buildings, etc.), drivable areas that constitute links or connections (e.g., drivable areas that form the same road) versus intersections (e.g., drivable areas where two or more roads intersect), and so on. The lanes and boundaries layer can include geospatial information of road lanes (e.g., lane centerline, lane boundaries, type of lane boundaries, etc.) and related attributes (e.g., direction of travel, speed limit, lane type, etc.). The lanes and boundaries layer can also include three-dimensional (3D) attributes related to lanes (e.g., slope, elevation, curvature, etc.). The intersections layer can include geospatial information of intersections (e.g., crosswalks, stop lines, turning lane centerlines and/or boundaries, etc.) and related attributes (e.g., permissive, protected/permissive, or protected only left turn lanes; legal or illegal u-turn lanes; permissive or protected only right turn lanes; etc.). The traffic controls lane can include geospatial information of traffic signal lights, traffic signs, and other road objects and related attributes.

The AV operational database 124 can store raw AV data generated by the sensor systems 104-108, stacks 112-122, and other components of the AV 102 and/or data received by the AV 102 from remote systems (e.g., the data center 150, the client computing device 170, etc.). In some examples, the raw AV data can include HD LIDAR point cloud data, image data, RADAR data, GPS data, and other sensor data that the data center 150 can use for creating or updating AV geospatial data or for creating simulations of situations encountered by AV 102 for future testing or training of various machine learning algorithms that are incorporated in the local computing device 110.

The data center 150 can include a private cloud (e.g., an enterprise network, a co-location provider network, etc.), a public cloud (e.g., an Infrastructure as a Service (IaaS) network, a Platform as a Service (PaaS) network, a Software as a Service (SaaS) network, or other Cloud Service Provider (CSP) network), a hybrid cloud, a multi-cloud, and/or any other network. The data center 150 can include one or more computing devices remote to the local computing device 110 for managing a fleet of AVs and AV-related services. For example, in addition to managing the AV 102, the data center 150 may also support a ridesharing service, a delivery service, a remote/roadside assistance service, street services (e.g., street mapping, street patrol, street cleaning, street metering, parking reservation, etc.), and the like.

The data center 150 can send and receive various signals to and from the AV 102 and the client computing device 170. These signals can include sensor data captured by the sensor systems 104-108, roadside assistance requests, software updates, ridesharing pick-up and drop-off instructions, and so forth. In this example, the data center 150 includes a data management platform 152, an Artificial Intelligence/Machine Learning (AI/ML) platform 154, a simulation platform 156, a remote assistance platform 158, and a ridesharing platform 160, and a map management platform 162, among other systems.

The data management platform 152 can be a “big data” system capable of receiving and transmitting data at high velocities (e.g., near real-time or real-time), processing a large variety of data and storing large volumes of data (e.g., terabytes, petabytes, or more of data). The varieties of data can include data having different structures (e.g., structured, semi-structured, unstructured, etc.), data of different types (e.g., sensor data, mechanical system data, ridesharing service, map data, audio, video, etc.), data associated with different types of data stores (e.g., relational databases, key-value stores, document databases, graph databases, column-family databases, data analytic stores, search engine databases, time series databases, object stores, file systems, etc.), data originating from different sources (e.g., AVs, enterprise systems, social networks, etc.), data having different rates of change (e.g., batch, streaming, etc.), and/or data having other characteristics. The various platforms and systems of the data center 150 can access data stored by the data management platform 152 to provide their respective services.

The AI/ML platform 154 can provide the infrastructure for training and evaluating machine learning algorithms for operating the AV 102, the simulation platform 156, the remote assistance platform 158, the ridesharing platform 160, the map management platform 162, and other platforms and systems. Using the AI/ML platform 154, data scientists can prepare data sets from the data management platform 152; select, design, and train machine learning models; evaluate, refine, and deploy the models; maintain, monitor, and retrain the models; and so on.

The simulation platform 156 can enable testing and validation of the algorithms, machine learning models, neural networks, and other development efforts for the AV 102, the remote assistance platform 158, the ridesharing platform 160, the map management platform 162, and other platforms and systems. The simulation platform 156 can replicate a variety of driving environments and/or reproduce real-world scenarios from data captured by the AV 102, including rendering geospatial information and road infrastructure (e.g., streets, lanes, crosswalks, traffic lights, stop signs, etc.) obtained from the map management platform 162 and/or a cartography platform; modeling the behavior of other vehicles, bicycles, pedestrians, and other dynamic elements; simulating inclement weather conditions, different traffic scenarios; and so on.

The remote assistance platform 158 can generate and transmit instructions regarding the operation of the AV 102. For example, in response to an output of the AI/ML platform 154 or other system of the data center 150, the remote assistance platform 158 can prepare instructions for one or more stacks or other components of the AV 102.

The ridesharing platform 160 can interact with a customer of a ridesharing service via a ridesharing application 172 executing on the client computing device 170. The client computing device 170 can be any type of computing system such as, for example and without limitation, a server, desktop computer, laptop computer, tablet computer, smartphone, smart wearable device (e.g., smartwatch, smart eyeglasses or other Head-Mounted Display (HMD), smart ear pods, or other smart in-ear, on-ear, or over-ear device, etc.), gaming system, or any other computing device for accessing the ridesharing application 172. In some cases, the client computing device 170 can be a customer's mobile computing device or a computing device integrated with the AV 102 (e.g., the local computing device 110). The ridesharing platform 160 can receive requests to pick up or drop off from the ridesharing application 172 and dispatch the AV 102 for the trip.

Map management platform 162 can provide a set of tools for the manipulation and management of geographic and spatial (geospatial) and related attribute data. The data management platform 152 can receive LIDAR point cloud data, image data (e.g., still image, video, etc.), RADAR data, GPS data, and other sensor data (e.g., raw data) from one or more AVs 102, Unmanned Aerial Vehicles (UAVs), satellites, third-party mapping services, and other sources of geospatially referenced data. The raw data can be processed, and map management platform 162 can render base representations (e.g., tiles (2D), bounding volumes (3D), etc.) of the AV geospatial data to enable users to view, query, label, edit, and otherwise interact with the data. Map management platform 162 can manage workflows and tasks for operating on the AV geospatial data. Map management platform 162 can control access to the AV geospatial data, including granting or limiting access to the AV geospatial data based on user-based, role-based, group-based, task-based, and other attribute-based access control mechanisms. Map management platform 162 can provide version control for the AV geospatial data, such as to track specific changes that (human or machine) map editors have made to the data and to revert changes when necessary. Map management platform 162 can administer release management of the AV geospatial data, including distributing suitable iterations of the data to different users, computing devices, AVs, and other consumers of HD maps. Map management platform 162 can provide analytics regarding the AV geospatial data and related data, such as to generate insights relating to the throughput and quality of mapping tasks.

In some examples, the map viewing services of map management platform 162 can be modularized and deployed as part of one or more of the platforms and systems of the data center 150. For example, the AI/ML platform 154 may incorporate the map viewing services for visualizing the effectiveness of various object detection or object classification models, the simulation platform 156 may incorporate the map viewing services for recreating and visualizing certain driving scenarios, the remote assistance platform 158 may incorporate the map viewing services for replaying traffic incidents to facilitate and coordinate aid, the ridesharing platform 160 may incorporate the map viewing services into the client application 172 to enable passengers to view the AV 102 in transit to a pick-up or drop-off location, and so on.

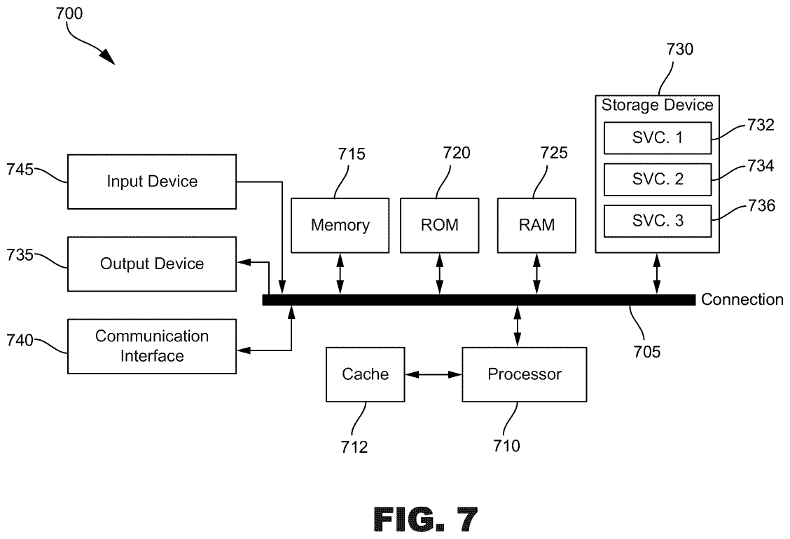

While the AV 102, the local computing device 110, and the autonomous vehicle environment 100 are shown to include certain systems and components, one of ordinary skill will appreciate that the AV 102, the local computing device 110, and/or the autonomous vehicle environment 100 can include more or fewer systems and/or components than those shown in FIG. 1. For example, the AV 102 can include other services than those shown in FIG. 1 and the local computing device 110 can also include, in some instances, one or more memory devices (e.g., RAM, ROM, cache, and/or the like), one or more network interfaces (e.g., wired and/or wireless communications interfaces and the like), and/or other hardware or processing devices that are not shown in FIG. 1. An illustrative example of a computing device and hardware components that can be implemented with the local computing device 110 is described below with respect to FIG. 7.

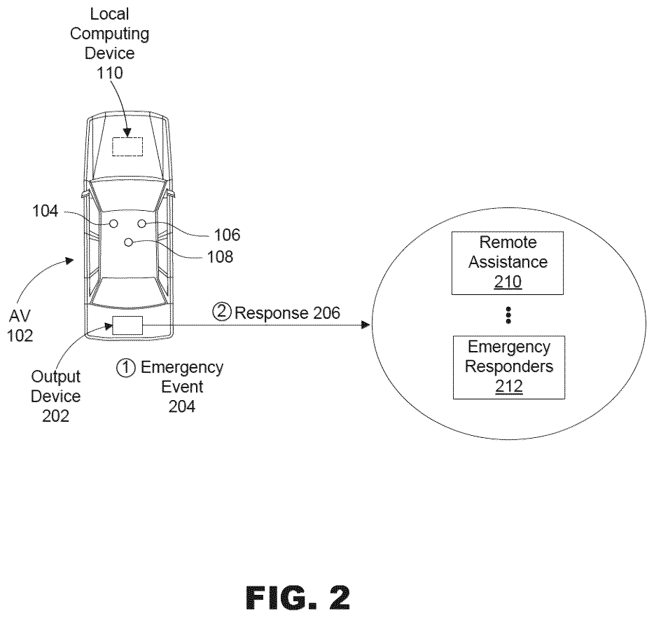

FIG. 2 is a diagram illustrating an example of an emergency event detection and automated response by AV 102. In this example, the AV 102 is experiencing an emergency event 204 that can trigger an automated response from the AV 102. In some cases, the emergency event 204 can include a degraded state of the AV 102 caused by an accident (e.g., a collision, etc.) between the AV 102 and one or more things (e.g., one or more vehicles, obstacles, animals, objects, pedestrians, etc.) and/or a problem with one or more components of the AV 102, such as a software and/or operating system of the AV 102, one or more of the sensor systems 104-108 of the AV 102, a mechanical system (e.g., vehicle propulsion system 130, braking system 132, steering system 134, safety system 136, etc.) of the AV 102, a hardware of the AV 102, one or more tires of the AV 102, and/or any other components of the AV 102.

In some cases, the emergency event 204 can additionally or alternatively include a condition of a passenger of the AV 102. For example, the emergency event 204 can include a health emergency of a passenger of the AV 102, an loss of consciousness of the passenger of the AV 102, an intoxicated state of the passenger of the AV 102, a sleeping state of the passenger of the AV 102, an incoherent or disoriented state of the passenger of the AV 102, a loss of one or more functions of the passenger of the AV 102 (e.g., a loss of hearing, a loss of sight, a loss of mobility of a limb or body of the passenger, etc.), or any other emergency state of the passenger of the AV 102.

The AV 102 can detect the emergency event 204 and trigger a response 206 to the emergency event 204. The AV 102 can detect the emergency event 204 using one or more of the sensor systems 104-108 of the AV 102. In some examples, the AV 102 can detect the emergency event 204 based on image data (e.g., video frames, still images, etc.) captured by one or more camera sensors of the AV 102. For example, the image data can depict an event(s) experienced by the AV 102, such as a collision, swerving, erratic driving behaviors, stopping in a dangerous or illegal/inappropriate location such as a bus lane, an emergency/fire lane, an area with incoming traffic (e.g., a middle of the road, an active road lane, etc.), a failure to follow one or more traffic rules or signs, dragging something on the AV 102 (e.g., an object or body part stuck in a door of the AV 102, an object hit and dragged by the AV 102, etc.), etc. The local computing device 110 of the AV 102 can detect the event(s) depicted in the image data and determine the emergency event 204 based on the detected event(s) in the image data. For example, if the image data depicts a collision involving the AV 102, the local computing device 110 can use the image data to detect the emergency event 204.

If the emergency event 204 includes a condition of a passenger of the AV 102 (e.g., intoxication, sleepiness or sleeping, a seizure, a stroke, a heart attack, a panic attack, a loss of consciousness, a decline of cognitive abilities, a loss of one or more senses (e.g., sight, hearing, touch, etc.), a loss in a motor function, a loss of control of one or more body parts, etc.), the image data can depict the passenger of the AV 102 and/or one or more aspects of the passenger of the AV 102 that the local computing device 110 can recognize as indicating a condition (e.g., the emergency event 204) of the passenger of the AV 102. For example, the image data captured by one or more camera sensors of the AV 102 can depict the passenger in a position that indicates the passenger may be in distress or otherwise experiencing a condition that necessitates assistance. To illustrate, if the image data depicts a passenger in a driver seat of the AV 102 laying down or at a certain angle (e.g., parallel to, slouched, etc.) relative to the floor of the AV 102, the local computing device 110 of the AV 102 may recognize that such position of the passenger indicates or suggests that the passenger may be in distress or otherwise experiencing a health condition that necessitates assistance.

For example, the position/posture of the passenger while operating the AV 102 can indicate that the passenger has fallen asleep, has lost or is losing consciousness, is intoxicated, is experiencing a cognitive event, is experiencing a medical emergency (e.g., a stroke, a heart attack, a loss of mobility, a loss of control of one or more body parts, a seizure, etc. As another example, the image data captured by the one or more camera sensors of the AV 102 can depict certain movements and/or actions by the passenger that the local computing device 110 can recognize as indicating that the passenger is experiencing the emergency event 204. To illustrate, if the local computing device 110 detects a threshold velocity of movement (e.g., falling/laying down, etc.) by the passenger as depicted in the image data, the local computing device 110 can determine that the passenger is intoxicated or has fallen asleep, lost consciousness, experienced a seizure, entered a manic state, etc. In some cases, the type of movement of the passenger can also indicate that the passenger is experiencing an emergency event. For example, certain types of movements such as shaking or erratic movements can indicate a seizure or intoxication.

As yet another example, the image data captured by the one or more camera sensors of the AV 102 can depict the eyes of the passenger in a state that indicates that the passenger is in distress, incapacitated, experiencing a health/medical condition, intoxicated, unable to safely drive or manage the AV 102, distracted, etc. For example, if the image data depicts the eyes of the passenger closed for a certain period of time, the local computing device 110 of the AV 102 may determine that the passenger has fallen asleep or lost consciousness. If the image data depicts the eyes of the passenger as being red and/or glossy, the local computing device 110 may determine that the passenger is intoxicated or experiencing a health emergency based on the red and/or glossy appearance of the eyes of the passenger. In some cases, the local computing device 110 may detect an eye gaze depicted in the image data and use the detected eye gaze to determine whether the passenger is intoxicated or experiencing a health condition/event.

For example, the local computing device 110 can implement an image processing algorithm for detecting eye gazes in image data. The local computing device 110 can use the algorithm to detect an eye gaze of the passenger. The local computing device 110 can determine, based on the detected eye gaze of the passenger, whether the passenger is distracted or intoxicated. As another example, if the local computing device 110 determines that the eye gaze of the passenger includes a “blank stare” of the passenger or a “blank stare” for a threshold period of time (e.g., a prolonged “blank stare”), the local computing device 110 can determine, based on the “blank stare”, that the passenger is distracted, intoxicated, experiencing a cognitive event, or otherwise unable to engage in the navigation/operation of the AV 102.

In some examples, a cabin (e.g., cabin system 138) of the AV 102 can include one or more interior sensors such as, for example and without limitation, one or more interior cameras, LIDARs, weight sensors, IMUS, depth or time-of-flight sensors, and/or any other sensors. In some cases, the one or more interior sensors can be used to detect a health/medical event based on a position/posture of a passenger of the AV 102, movement (or lack thereof) or activity (or lack thereof) of the passenger within a threshold period of time, an eye gaze of the passenger, one or more characteristics of the passenger's eyes (e.g., red eyes, glossy eyes, a blank stare, etc.), a size of the pupils of the passenger, a type of motion of the passenger (e.g., jerking, erratic, static, etc.), the passenger maintaining his/her eyes closed for a threshold period of time, and/or other characteristics of the passenger.

For example, in some cases, the image data can include one or more images and/or video feeds from one or more interior cameras on the cabin of the AV 102. The image data can depict a position/posture of a passenger of the AV 102 for a period of time. The AV 102 can use the image data to determine whether the passenger is periodically moving forward or leaning forward in a certain way, whether the passenger is periodically falling down or to the side, whether one or more portions of the body of the passenger are bent in an unnatural manner, whether the eyes of the passenger remain closed for a threshold period of time, whether the eyes of the passenger are red and/or glossy, whether the pupils of the passenger are dilated or constricted, etc. The AV 102 can use this information to detect a health/medical event associated with the passenger.

As another example, the cabin of the AV 102 can include weight sensors on the seats of the AV 102 and seat belt sensors. If the AV 102 detects a sudden reduction in weight on a seat (e.g., as detected by a weight sensor on the seat) and/or a seat belt on that seat being removed or pulled with a threshold amount of force in a certain direction, the AV 102 can determine that a passenger on that seat has fallen from the seat. The AV 102 can then infer a health/medical event based on the determination that the passenger has fallen from the seat.

In some cases, the AV 102 can generate a prompt for the passenger requesting an action or response by the passenger, such as a verbal/speech response, a particular movement or action, etc. In some examples, the AV 102 can tailor the prompt to the primary or preferred language of the passenger (e.g., as indicated by the passenger, a profile associated with the passenger, etc.). In other examples, the AV 102 can generate the prompt in several languages. For example, the AV 102 can rotate versions of the prompt in several languages. In some cases, the AV 102 can tailor the prompt to one or more characteristics of the passenger such as, for example, an age of the passenger, a language of the passenger, a health condition of the passenger, a preference(s) of the passenger, a cognitive ability of the passenger, etc. In some examples, the AV 102 can additionally or alternatively tailor the prompt to a specific emergency event, such as a health/medical event, a vehicle emergency event (e.g., a collision, a failure, a malfunction, a system error, etc.). For example, if an emergency event detected by the AV 102 includes a loss of sight, the AV 102 can generate an audio prompt rather than a visual prompt. As another example, if the emergency event is a health/medical event affecting the passenger's ability to hear, the AV 102 can generate a visual prompt rather than an audio prompt.

The AV 102 can use the output device 202 to output the prompt for the passenger. In some examples, the output device 202 can include a speaker(s), a screen(s) or display(s), a touchscreen, a communications interface, and/or any other output device or combination of output devices. In some cases, the prompt provided via the output device 202 can request the passenger to speak to allow the local computing device 110 to assess/analyze the passenger's speech and/or response for a potential emergency event (e.g., emergency event 204). The local computing device 110 can use the passenger's response to the prompt (or lack thereof) to determine whether the passenger is experiencing the emergency event 204.

In some examples, the AV 102 can output an audible prompt for the passenger using one or more speakers of the AV 102 (e.g., output device 202), a visual prompt presented on a screen or display device of the AV 102 (e.g., output device 202), and/or a message (e.g., audible and/or visual) sent by the AV 102 (e.g., via output device 202) to a mobile device (e.g., a mobile phone, a tablet computer, a smart wearable device, etc.) of the passenger instructing the passenger to speak, utter certain words or phrases, and/or perform certain actions selected to test a responsiveness and/or state of the passenger. The AV 102 can use a microphone on the AV 102 to record any audio response from the passenger. The local computing device 110 can analyze an audio response (e.g., using a speech recognition algorithm, using a machine learning algorithm, and/or any other suitable algorithm) by the passenger to determine whether the audio response indicates any health/medical or risk events associated with the passenger, such as emergency event 204.

If the local computing device 110 determines that the passenger does not respond to any of the prompts provided by the AV 102, the local computing device 110 can determine that the passenger is experiencing a health/medical event (e.g., intoxication, sleeping, a seizure, a stroke, a heart attack, a loss of consciousness, a degradation of a cognitive ability/condition, etc.) or can confirm a determination made by the local computing device 110 using the image data that the passenger is experiencing a health/medical event (e.g., intoxication, sleepiness, a seizure, a health emergency such as a stroke or heart attack, etc.). On the other hand, if the passenger does respond to the prompt to speak, the local computing device 110 can analyze the audio response of the passenger (e.g., the spoken response) to determine that the passenger is experiencing a health/medical event (e.g., intoxication, sleeping, a seizure, a stroke, a heart attack, a loss of consciousness, a degradation of a cognitive ability/condition, etc.) or confirm a determination made by the local computing device 110 using the image data that the passenger is experiencing a health/medical event (e.g., intoxication, sleepiness, a seizure, a health emergency such as a stroke or heart attack, etc.).

To illustrate, the local computing device 110 can confirm that the passenger is intoxicated or cognitively affected by a health event/condition based on one or more characteristics of the passenger's audio response such as, for example, whether the passenger is slurring his/her speech, the volume of the passenger's speech (e.g., overly loud speech may indicate intoxication or a cognitive event/decline), the content of the passenger's speech (e.g., speech unresponsive to a prompt can indicate intoxication or a cognitive event/decline, nonsensical speech may indicate intoxication or a cognitive event/decline, one or more speech patterns can indicate intoxication or a cognitive event/decline, etc.), the timing of the passenger's speech relative to one or more prompts (e.g., a longer delay in responding to a prompt may indicate intoxication or a cognitive event/decline), and/or any other characteristics of the passenger's speech (or the lack of speech).

In some cases, the local computing device 110 can implement a machine learning algorithm to learn characteristics of speech of the passenger when the passenger is in a healthy/normal state and/or when the passenger is not in a healthy/normal state. For example, the local computing device 110 can implement a machine learning algorithm trained to detect cognitive issues of the passenger based on one or more characteristics of an audio response or utterance of the passenger. The one or more characteristics of the audio response can include, for example and without limitation, a frequency or tempo/speed of the speech, a volume of the speech, a tone and/or pitch of the speech, a content of the speech, a clarity of the speech, an amount of time or delay in responding to a prompt, etc.

In some examples, the local computing device 110 can use data from one or more other sensors to detect the emergency event 204. For example, the local computing device 110 can use data from an inertial measurement unit (IMU) to detect a threshold amount of deceleration over a period of time that indicates a collision, a maneuver to avoid a collision, etc. In this example, the local computing device 110 can use the IMU data to detect the emergency event 204 based on a threshold deceleration indicated in the IMU data or a threshold deceleration over a certain distance and/or time. In some cases, the local computing device 110 can use data from an internal IMU to determine a certain movement by the passenger that indicates that the passenger has experienced the emergency event 204. For example, if the IMU data indicates that the passenger has fallen from a sitting position to a position laying down or slouching. The local computing device 110 can detect the emergency event 204 based on the IMU data indicating that the passenger has fallen from a sitting position to a position laying down or slouching.

In some cases, the local computing device 110 may set one or more thresholds for detecting the emergency event 204 based on movements represented in the IMU data. For example, the local computing device 110 can set a threshold change in an angle of the passenger's position/posture, a threshold amount of time between a sitting position of the passenger and a changed position of the passenger, and/or a threshold frequency in changes in the angle of the passenger's position/posture indicative of the emergency event 204. Thus, when the IMU data indicates that the one or more thresholds set by the local computing device 110 are met, the local computing device 110 can determine that the emergency event 204 has occurred.

As another example, the local computing device 110 can use data from a weight sensor on a seat(s) of the AV 102 to detect the emergency event 204. For example, if data from the weight sensor indicates that the passenger has changed a position or posture from a sitting position to a position laying down or a position with a certain angle, the local computing device 110 can use that data to detect the emergency event 204, as the changed position/posture and/or angle can indicate that the passenger has fallen asleep, lost consciousness, experienced a seizure, is intoxicated, etc.

In some cases, the local computing device 110 can detect the emergency event 204 based on data from a seat belt sensor, an airbag sensor, a tire pressure sensor, an odor sensor, a smoke sensor, a humidity sensor, a light sensor, an impact sensor, a LIDAR, a RADAR, and/or any other type of sensor. For example, the local computing device 110 can detect the emergency event 204 based on data from an airbag sensor indicating that an airbag has been deployed (which can indicate that the AV 102 was involved in a collision), data from an impact sensor indicating a collision involving the AV 102, data from a tire pressure sensor indicating a flat tire, data from a seat belt sensor indicating that the seat belt was activated potentially as a result of a collision, an odor sensor indicating a presence of drugs or alcohol, a presence of a potentially harmful odor, and/or an odor commonly present in vehicle collisions. Example odors that can trigger a detection of the emergency event 204 can include, without limitation, a gas odor, a chemical odor, an alcohol odor, a drug odor, an odor of a burning material, etc. In some cases, the local computing device 110 can use data from a smoke sensor to detect smoke (which can indicate a fire, an explosion, etc.) and trigger a detection of the emergency event 204 based on the detected smoke.

In some cases, the local computing device 110 can detect the emergency event 204 based on a detected impact using an impact sensor. In other examples, the local computing device 110 can use data from a LIDAR, a RADAR, and/or a motion detector to detect the emergency event 204. In some cases, the LIDAR, RADAR, and/or motion detector can measure information indicative of a collision involving the AV 102, a failure of the AV 102, and/or a movement and/or posture of a passenger of the AV 102 (which can indicate the occurrence of the emergency event 204). In some examples, the local computing device 110 can use data from different sensors to detect the emergency event 204 and/or confirm a detection of the emergency event 204. For example, the local computing device 110 can use a type of sensor to detect the emergency event 204 and a different type of sensor to confirm the emergency event 204. To illustrate, the local computing device 110 can use data from a first type of sensor (e.g., a camera sensor, an audio sensor, a LIDAR, an impact sensor, an airbag sensor, a seat belt sensor, a weight sensor, a tire pressure sensor, an IMU, an odor sensor, a smoke sensor, etc.) or a first set of sensors to detect the emergency event 204, and use data from a second type of sensor (or a second set of sensors) to confirm the emergency event 204.

In response to detecting the emergency event 204, the AV 102 can automatically generate a response 206 to the emergency event 204. The response 206 can include performing an action(s), generating an alert(s), sending a signal(s) and/or communication(s), establishing a call, changing a behavior and/or mode of the AV 102, outputting information, requesting help, etc.

For example, the response 206 can include, without limitation, contacting law enforcement if the emergency event 204 includes an accident and/or criminal activity, reporting an issue to a passenger of the AV 102 (e.g., reporting a battery issue, reporting a flat tire or loss of air pressure, reporting a problem with a braking system, reporting a problem with one or more sensors of the AV 102, reporting a problem with a lighting system of the AV 102, etc.), requesting an action by a passenger of the AV 102 (e.g., requesting contacting emergency responders, requesting stopping of the AV 102, requesting evacuation of the AV 102, requesting driving the AV 102 to a particular/safe spot, requesting a check of one or more potentially malfunctioning systems, requesting information, etc.), initiating a voice and/or video call/communication between the passenger and a remote agent (e.g., an emergency responder, a remote assistance agent, an emergency contact, etc.), terminating a trip, escalating an assistance response/request, trigger a different waypoint for the AV 102 to move elsewhere or to a different path, sending a notification to one or more devices and/or parties, requesting help from one or more third parties (e.g., emergency responders, remote assistance entities, etc.), automatically unlocking and opening one or more doors of the AV 102, contacting a parent/guardian/caregiver if the passenger is under age or requires a guardian or caregiver, generating instructions to evacuate the AV 102, generating instructions to perform one or more actions in response to the emergency event 204, emitting an alert (e.g., a sound alert, a visual alert, a message alert, etc.), activating one or more AV systems (e.g., lights/blinkers of the AV 102, a horn of the AV 102, a navigation stack of the AV 102, etc.), sending a notification to one or more devices (e.g., to a device of a passenger, to a device of an emergency contact, to a device of an emergency responder, to a traffic device, etc.), broadcasting or sending a signal to another vehicle through a vehicle-to-vehicle (V2V) communication, activating an AV degraded mode where the AV 102 can still drive away from a situation even if one or more components/systems of the AV 102 fail and/or experience problems, establishing a video and/or audio call with one or more parties, triggering one or more AVs to creating a roadblock to protect the AV 102 and/or redirect traffic, outputting alerts and/or messages, moving the AV 102, contacting emergency services, contacting an emergency contact, turning off the AV 102 and/or a battery of the AV 102 to reduce a risk of fire and/or explosion, locking the doors of the AV 102 if there is a security threat/concern, coordinating actions with a remote backend system/personnel (e.g., remotely locking and/or unlocking of doors, remotely turning on or off the AV 102 and/or one or more components of the AV 102, remotely controlling an engine of the AV 102, etc.), and/or any other actions.

In the example shown in FIG. 2, the response 206 includes contacting a remote assistance backend 210 and/or emergency responders 212 for help. The AV 102 can contact the remote assistance backend 210 and/or the emergency responders 212 automatically in response to detecting the emergency event 204. In some examples, the AV 102 can use the output device 202 to contact the remote assistance backend 210 and/or the emergency responders 212. In some cases, the output device 202 can include a wireless device that can wirelessly contact one or more devices of the remote assistance backend 210 and/or the emergency responders 212. For example, the output device 202 can include a cellular communications device that can wirelessly contact the remote assistance backend 210 and/or the emergency responders 212. In other examples, the output device 202 can additionally or alternatively include a communications device for other types of wireless communications such as, for example, WIFI communications, Bluetooth communications, V2V communications, vehicle-to-infrastructure (V2I) communications, and/or any other wireless device.

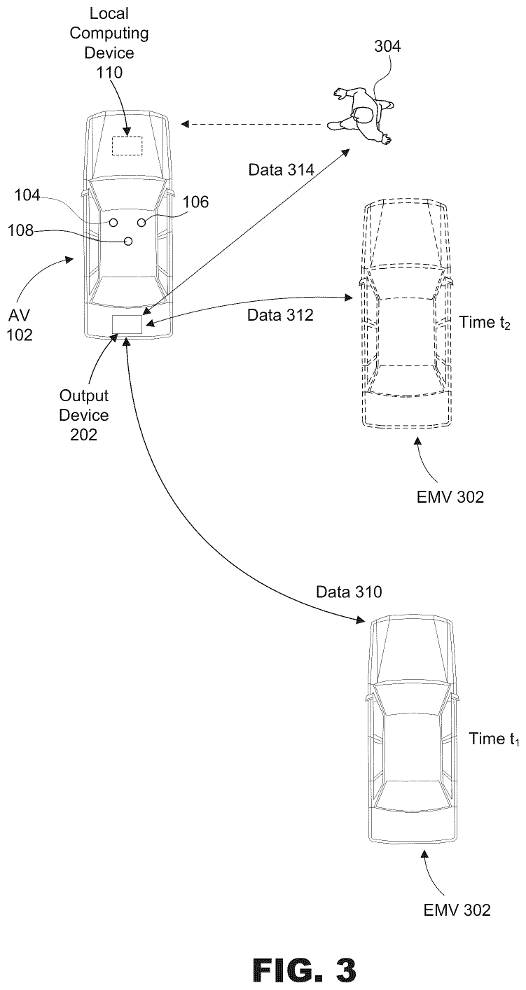

FIG. 3 is a diagram illustrating an example automated AV response to a detected emergency event, such as emergency event 204 shown in FIG. 2. In this example, the automated response to the detected emergency event by the AV 102 includes providing information to an emergency vehicle (EMV) 302 called to the scene and a first responder 304 in the scene. The AV 102 can provide data 310 to the EMV 302 while the EMV 302 is en route to the scene of the AV 102. In some examples, the AV 102 can send the data 310 to the EMV 302 (and/or to a device in communication with the EMV 302) using the output device 202. For example, the output device 202 can use wireless communications (e.g., cellular or any other wireless communications) to send the data 310 to the EMV 302. In some examples, the output device 202 can include a wireless transceiver. In some cases, the output device 202 can include multiple devices such as a wireless transceiver and one or more additional devices (e.g., a speaker, a microphone, a screen/display, a light system, a sensor, etc.).

The data 310 can include, for example and without limitation, context information about the emergency event (e.g., details about the emergency event, information about the AV 102 and/or passenger before and/or after the emergency event, a code(s) that the emergency responders in the EMV 302 can use to access the AV 102 and/or the passenger(s) of the AV 102 (e.g., a code to unlock and open one or more doors of the AV 102, a code to turn on or off the AV 102 and/or one or more components of the AV 102, etc.), measurements during the emergency event, conditions leading to the emergency event, conditions resulting from the emergency event, type of assistance needed/requested, road conditions, vehicle conditions, etc.), information about any passengers of the AV 102 (e.g., the number of passengers, an identity of each passenger, an age of each passenger, a gender of each passenger, a description of each passenger, a condition/status of each passenger, medical/health information of each passenger, a location of each passenger within the AV 102, a description of any injuries of any passengers, a description of the emergency event associated with the AV 102, data captured (before, during, and/or after the emergency event) by one or more sensors of the AV 102 (e.g., image data, audio data recorded, inertial measurements, impact measurements, weather data, environment data, vehicle status information, a measured speed of the AV 102 (e.g., before, during, and/or after the emergency event), any smoke detector measurements, any odor detector measurements, recorded emergency event measurements/statistics, odometer readings, etc.), user profile information, vehicle information, road information, traffic information, information about any passenger devices (e.g., a mobile phone, a tablet computer, a smart wearable device, etc.), insurance information, emergency contact information, information about any primary care professionals associated with any passengers of the AV 102, instructions, recorded audio and/or visual data from any passengers of the AV 102, a vehicle history report, navigation information, location information, any other data relevant to the emergency event or the assistance needed/requested, and/or any combination thereof.

In some examples, medical/health information of a passenger is only shared if the passenger (or a guardian) accepts or agrees to have such information shared for the purposes of obtaining help for an emergency event. In some cases, the medical/health information can be requested from a passenger of the AV 102 prior to sending the data 310. For example, the medical/health information can be requested from a passenger via an audio and/or visual prompt. In other cases, the medical/health information can be obtained from an existing profile of the passenger. In some examples, a profile of a passenger can additionally or alternatively include other information such as, for example and without limitation, an identity of the passenger, an emergency contact of the passenger, information about a primary care provider of the passenger, a medical history of the passenger, insurance information of the passenger, one or more preferences of the passenger (e.g., assistance preferences, a will, a do not resuscitate document, an organ donation preference, a preference for communications (e.g., voice, video, message, etc.), a hospital preference, a vehicle service provider preference, etc.

The AV 102 can continue to provide data (e.g., data 310) to the EMV 302 while the EMV 302 is en route to the scene of the AV 102. For example, the AV 102 can periodically provide updates to the EMV 302 to ensure the EMV 302 has the latest information and/or more comprehensive information about the emergency event prior to even arriving at the scene. The information can help the emergency responders in the EMV 302 plan/prepare to provide assistance to the passenger(s) of the AV 102, provide better assistance to the passenger(s) of the AV 102, reduce an amount of time that the emergency responders in the EMV 302 spend understanding the emergency event and/or how to provide assistance to the passenger(s) of the AV 102, ensure that the necessary resources and/or emergency personnel are used/included in the emergency response, ensure that the emergency responders in the EMV 302 have sufficient context and other information to provide assistance, ensure that the emergency responders in the EMV 302 have access to the AV 102 and/or the passenger(s) of the AV 102, and/or facilitate the emergency responders' assistance to the passenger(s) of the AV 102 and any others in the scene needing help.

In some examples, if the AV 102 determines a risk of data loss before all the relevant data is sent to or offloaded to the EMV 302 (and/or any other destination), the AV 102 can prioritize which data or portions of data are transmitted to the EMV 302 first and/or can send portions of the data 310 in an order according to priorities of the data 310. For example, if the AV 102 has a fire and there is a risk that the data stored at the AV 102 may be lost or damaged by the fire, the AV 102 can prioritize the data provided to the EMV 302 so the most relevant/important data is provided first so that if the fire causes data loss, the more relevant/important data is more likely to be offloaded before the fire causes the data loss. To illustrate, if there is a fire at the AV 102 that may cause data loss, the AV 102 may prioritize sending to the EMV 302 any sensor data that will better help the emergency responders provide assistance to the passenger(s) of the AV 102 and/or understand the emergency event, and deprioritize other data that may be less relevant to the emergency event and/or less helpful to the emergency responders with regards to understanding the emergency event and providing help to the passenger(s) of the AV 102.

As an example, the data 310 may include an access code configured to allow the emergency responders in the EMV 302 to unlock doors of the AV 102, sensor data captured immediately before the emergency event which provides context for the emergency event and measurements/recordings that help others understand the emergency event (e.g., the cause of the emergency event, the conditions at the time of the emergency event, dangers associated with the emergency event, etc.), as well as older sensor data that is less relevant to the emergency event. Here, if there is a fire that could potentially cause the data 310 to be lost, the AV 102 can first send high priority data (e.g., data given the highest priority) which in this example includes the access code for allowing the emergency responders to unlock the doors of the AV 102 in order to provide assistance, as well as the sensor data captured immediately before the emergency event which provides a context for the emergency event and measurements/recordings that help others understand the emergency event. The lower priority data, which in this example includes the older sensor data, can be held for transmission after the high priority data has been completely offloaded. When the AV 102 completes offloading the high priority data (e.g., providing the high priority data to the EMV 302 and/or a remote device), the AV 102 can then try to offload (e.g., send) the lower priority data (e.g., the older sensor data) if the fire has not yet damaged such data or the ability of the AV 102 to offload such data.

This way, the AV 102 can offload as much of the most relevant/important data as it can before any data is lost due to the fire or the ability of the AV 102 to transmit the data is negatively affected by the fire. In other words, if the time the AV 102 has to offload the data 310 is limited due to a potential/imminent data loss (or loss of data transmission capabilities) caused by the fire, the AV 102 can prioritize offloading the most important data first to prevent or limit the amount of such important data that is lost (if any) before it is offloaded. Here, the less important/relevant data will not consume valuable and limited time and bandwidth for offloading data during the emergency event before the more important/relevant data is offloaded so as to reduce or prevent the loss of more important/relevant data relative to the less important/relevant data.

The AV 102 can also provide data 312 to the EMV 302 when the EMV 302 arrives at the scene. In some examples, the data 312 can include a code for accessing the AV 102 (e.g., a code for unlocking and/or opening doors of the AV 102), instructions for accessing the AV 102 and/or controlling the AV 102, updates of a status of the AV 102 and/or any passengers of the AV 102, visual and/or audio alerts, context information, sensor data captured by one or more sensors of the AV 102 (e.g., sensor systems 104-108), updated measurements/recordings, a description of actions taken (e.g., by the AV 102, a passenger(s) of the AV 102, and/or nearby individuals) prior to the EMV 302 arriving at the scene, and/or any other information. In some cases, the data 312 can include priority information. The priority information can prioritize the type of assistance needed/requested, which passengers are prioritized (e.g., passengers with more severe injuries can be prioritized over other passengers, older passengers can be prioritized over younger passengers, passengers with health conditions can be prioritized over other passengers, more vulnerable passengers can be prioritized over less vulnerable ones, etc.

In some examples, if the AV 102 includes certain tools such as a first aid kit, a defibrillator, a glucose monitor, etc., the data 312 can include an instruction on how to use such tools for a particular emergency event. For example, if the AV 102 detects an emergency event including a heart-related problem of a passenger that can be addressed/helped with a defibrillator, the data 312 can include an audio and/or video tutorial or guide on how to use a defibrillator on the AV 102.

In some cases, the data 312 can identify potential risks or threats to the passenger(s) of the AV 102, the emergency responders in the EMV 302, nearby individuals, incoming traffic, and/or any other parties or vehicles. In some examples, the data 312 can include an access code to allow the emergency responders from the EMV 302 to unlock doors of the AV 102, access certain areas of the AV 102, authenticate themselves to the AV 102 and/or the passenger(s) of the AV 102 (e.g., to authenticate themselves to the passenger for security reasons and/or to establish trust), etc. In some cases, the data 312 can include any sensor data, updates, measurements, and/or recordings from the AV 102. The output device 202 can provide such information to the EMV 302 to provide the emergency responders in the EMV 302 information that they can use to better assist the passenger(s) of the AV 102. In some examples, the data 312 can include information about potential risks/dangers in the scene, such as incoming traffic, blind spots, criminal activity, chemical hazards, fire hazards, etc.

In some cases, the AV 102 can also provide data 314 to any individuals in the scene. For example, the AV 102 can provide (e.g., via the output device 202) the data 314 to a first responder 304 in the scene. The first responder 304 can include an emergency responder, such as a police office, a firefighter, an emergency medical technician (EMT), a medical professional, and/or any other emergency responder. In other cases, the first responder 304 can include an individual at the scene attempting to provide assistance to the passenger(s) of the AV 102.

The AV 102 can provide the data 314 to the first responder 304 via the output device 202. In some examples, the data 314 can include audio data provided via a speaker of the output device 202, visual data presented via a screen/display (e.g., a head-up display, a standalone display, a screen incorporated in a window of the AV 102, etc.) of the output device 202 and/or projected via the output device 202, text data transmitted via the output device 202 for display at one or more remote devices (e.g., for display on a mobile device of one or more individuals at the scene, for display on a screen/display of the AV 102, for display on a screen/display of the first responder 304, etc.), and/or any combination of data.

In some cases, the data 314 can include instructions for the first responder 304 guiding the first responder 304 to access the AV 102 and/or provide assistance to the passenger(s) of the AV 102. In other cases, the data 314 can additionally or alternatively include an access code that the first responder 304 can use to unlock/open doors of the AV 102, authenticate himself/herself to the passenger of the AV 102, and/or access and/or control one or more systems of the AV 102.

In some examples, the AV 102 can activate/engage one or more systems of the AV 102 to help the emergency responders provide assistance. For example, the AV 102 can activate a lighting system to increase an amount of light in the scene to increase a visibility of emergency responders in the scene when providing assistance to the passenger(s) of the AV 102. As another example, the AV 102 can activate a lighting system, a horn, and/or a speaker system of the AV 102 to output audio and/or visual alerts to others in the scene, such as incoming traffic, to reduce a risk of a collision with the AV 102 during the emergency event.

In some cases, the AV 102 can detect when the EMV 302 is within a proximity to the AV 102. For example, the AV 102 can detect sirens, lights, emergency vehicles, etc., and determine that the EMV 302 is within a proximity to the AV 102. In some aspects, the AV 102 can then generate a message for the passenger(s) of the AV 102 indicating that the EMV 302 has arrived or is within a certain proximity to the AV 102. In some examples, the message can include an audio message output via one or more speakers on the AV 102 and/or a visual message output via one or more screens or displays of the AV 102. In some cases, the AV 102 can send the message to a device (e.g., a mobile phone, a tablet computer, a laptop computer, a smart wearable device, smart glasses, etc.) of a passenger for output via the device of the passenger.

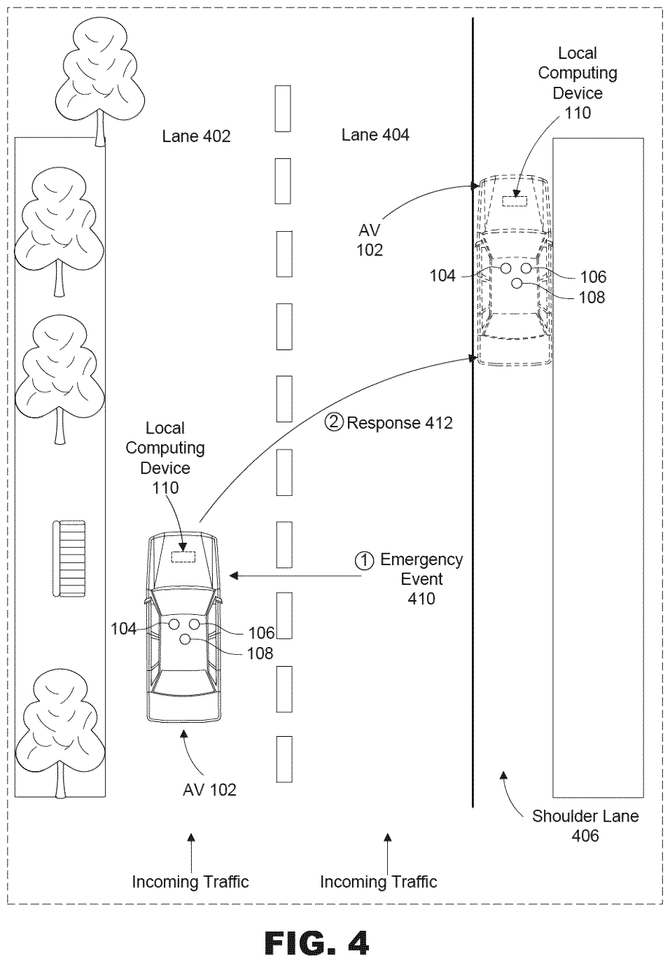

FIG. 4 is a diagram illustrating an example action taken by the AV 102 in response to a detected event. As shown, the AV 102 is traveling in lane 402 when it encounters an emergency event 410. The AV 102 can use the sensor systems 104-108 of the AV 102 to detect the emergency event 410 and trigger a response 412 to the emergency event 410. The AV 102 can determine that it needs to stop or will be forced to stop as a result of the emergency event 410. However, if the AV 102 stops in lane 402 or lane 404, there is a risk that incoming traffic in lane 402 or lane 404 may collide with the AV 102 while the AV 102 is stopped at lane 402 or lane 404. If the AV 102 is able to continue to operate for long enough to move the AV 102 out of lane 402 or lane 404, the AV 102 can continue to move to seek a safer spot to stop before it is unable to move any further as a result of the emergency event 410.

Thus, in this example shown in FIG. 4, to prevent the risk of incoming traffic in lane 402 or lane 404 colliding with the AV 102 if the AV 102 stops at lane 402 or lane 404, the AV 102 can select to move to the shoulder lane 406 and stop once the AV 102 is in the shoulder lane 406, which is not expected to have incoming traffic. Accordingly, to prevent or mitigate the risk of a collision, the response 412 triggered by the emergency event 410 detected by the AV 102 can include moving the AV 102 to the shoulder lane 406 and stopping the AV 102 once the AV 102 is in the shoulder lane 406. The AV 102 can park in the shoulder lane 406 while it seeks assistance so the AV 102 can move (or can be moved) out of the way of incoming traffic.

In some cases, if the AV 102 is unable to move to a safer stopping location, the AV 102 can generate one or more alerts for incoming traffic. The AV 102 can output such alerts while it is stopped and waiting for assistance (and/or to be moved) to prevent or reduce the risk of a collision with oncoming traffic.

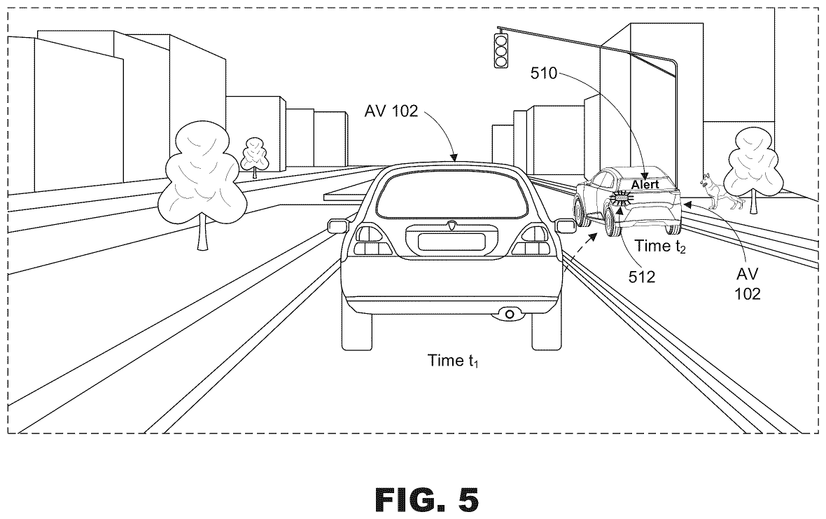

FIG. 5 is a diagram illustrating example alerts generated by the AV 102 when stopped due to an emergency event. In this example, the AV 102 has experienced an emergency event while traveling on a road. The road does not include a shoulder lane that provides a safer place for the AV 102 to move to when experiencing an emergency event as shown in FIG. 4. Instead, the AV 102 has moved to an outer lane in the road and generated alerts for incoming traffic. The alerts are intended to inform the incoming traffic that the AV 102 has experienced an emergency event and is stopped, in order to give the incoming traffic more time to reach and hopefully avoid a collision with the AV 102.

In this example, the alerts include a visual alert 510 presented on a rear of the AV 102 to visibly notify incoming traffic that the AV 102 is stopped in order to prevent or reduce the risk of the incoming traffic colliding with the AV 102. For example, the visual alert 510 can include a visual message and/or a visualization displayed on a screen incorporated on a rear window of the AV 102. The visual alert 510 can be displayed on a rear of the AV 102 because the rear of the AV 102 faces incoming traffic and thus is easier for the incoming traffic to see (thereby increasing the likelihood that incoming vehicles will see the visual alert 510 and thus will be able to reach accordingly to avoid colliding with the AV 102. In other cases, the AV 102 may display the visual alert in another location. For example, the location where the AV 102 displays the visual alert can depend on the location of the AV 102 relative to incoming traffic.

To illustrate, if the incoming traffic faces a side of the AV 102, the AV 102 can instead display the visual alert on an area within the side of the AV 102 facing the incoming traffic. By displaying the visual alert on an area facing oncoming traffic, the AV 102 can increase the likelihood that the incoming traffic will see the visual alert and will be able to react accordingly to avoid a collision with the AV 102. In some cases, the AV 102 can display visual alerts on multiple areas of the AV 102 to increase the likelihood that other vehicles on the road will be able to see the AV 102 and take appropriate action to prevent a collision with the AV 102 while the AV 102 is stopped.

The visual alert 510 can include text, an animation or visualization, a video, an image, a color pattern, and/or any other visual alert. For example, in some cases, the visual alert 510 can include text displayed by the AV 102 informing other vehicles that the AV 102 is stopped and/or has experienced an emergency event. In some cases, the AV 102 can output multiple alerts and/or multiple types of alerts to inform other vehicles that the AV 102 is stopped so the other vehicles can take appropriate action to prevent a collision with the AV 102. For example, the AV 102 can output the visual alert 510 and one or more additional alerts such as, for example, an audio alert (e.g., an audio alert outputted by a speaker of the AV 102, a noise generated by a horn of the AV 102 to get the attention of other vehicles, etc.), a different visual alert, a V2V signal, and/or any other alert.

In the example shown in FIG. 5, the AV 102 has also used a tail light of the AV 102 to output another visual alert 512 to increase the likelihood that incoming vehicles will recognize that the AV 102 is stopped. The visual alert 512 can include light or a pattern of light emitted by the tail light of the AV 102. For example, the visual alert 512 can include a pattern of flashing light emitted by the tail light of the AV 102. In some cases, the characteristics of the visual alert 512 emitted by the tail light can be configured to draw the attention of other drivers to warn the other drivers that the AV 102 is stopped.

For example, the AV 102 can use a particular color (or colors), light intensity (or light intensities), and/or pattern(s) of light for the visual alert 512 to increase the likelihood that the visual alert 512 will be seen by other vehicles/drivers on the road. The color, light intensity, and/or pattern of light used for the visual alert 512 can be designed to be more noticeable to the human eye and conspicuously displayed to draw the attention of other vehicles and drivers on the road, and thus provide warning to the other vehicles and drivers to reduce a likelihood of other vehicles colliding with the AV 102 while the AV 102 is stopped.

In some cases, the AV 102 can display the visual alert 512 in addition to the visual alert 510. The multiple visual alerts can increase the likelihood of the visual alerts being noticed by other vehicles and drivers, and thus can decrease the likelihood of other vehicles colliding with the AV 102 while the AV 102 is stopped because of the emergency event. In other cases, the AV 102 can display the visual alert 512 in lieu of the visual alert 510, or the visual alert 510 in lieu of the visual alert 512. In some examples, the AV 102 can output an audio alert (e.g., generated by a horn of the AV 102 and/or a speaker of the AV 102) in addition to the visual alert 510 and/or the visual alert 512 in order to provide different alert modes and thus increase the likelihood of other vehicles and drivers perceiving at least one alert.

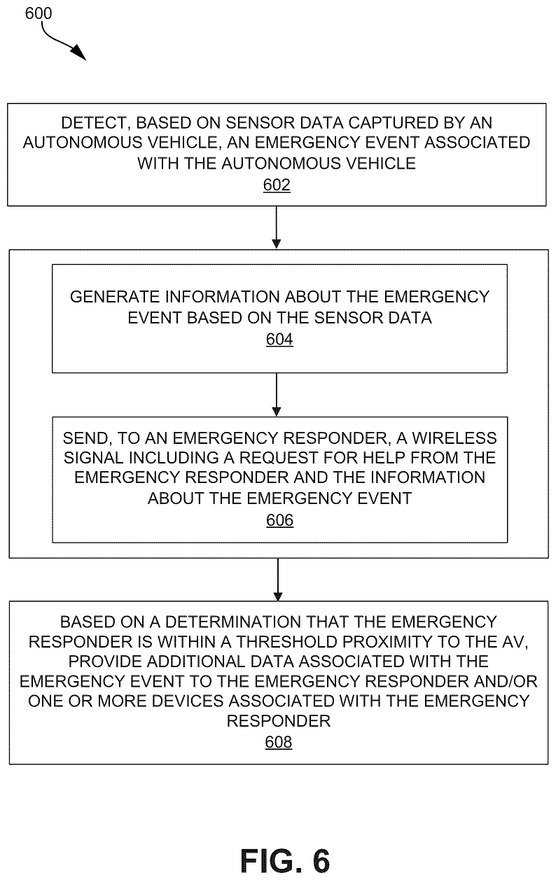

FIG. 6 is a flowchart illustrating an example process 600 for detecting emergency AV events and automatically generating a response. At block 602, the process 600 can include detecting, based on sensor data captured by an AV (e.g., AV 102), an emergency event associated with the AV. For example, the AV can include one or more sensors (e.g., sensor system 104, sensor system 106, sensor system 108) configured to capture sensor data associated with the emergency event. The one or more sensors can include, for example and without limitation, a camera sensor, an IMU, a LIDAR, a RADAR, a depth or time-of-flight sensor, an audio sensor, a light sensor, a weight sensor, a tire pressure sensor, an airbag sensor, an impact sensor, a door sensor, a motion sensor, a temperature sensor, a humidity sensor, and/or any other type of sensor.

In some cases, the emergency event can include a health/medical event associated with a passenger of the AV, such as a stroke, a heart attack, a diabetic event, a hypoglycemic event, a hyperglycemic event, a seizure, a loss of consciousness, a bone fracture, a concussion, a drug overdose or intoxication, an alcohol overdose or intoxication, a panic attack, and/or any other type of health event. In some cases, the emergency event can include a vehicle emergency such as, for example, a collision, a failure or error of a software or operating system of the AV, a failure or error of a hardware component of the AV, a failure or malfunction of a mechanical system of the AV, a battery problem, an engine problem, a problem with an electrical system of the AV, a flat tire, an accident, and/or any other type of vehicle event.

At block 604, the process 600 can include, in response to detecting the emergency event: generating information about the emergency event based on sensor data captured by the AV. In some examples, the information about the emergency event can include a description of the emergency event, an indication of a number of passengers of the AV, an identity of one or more passengers of the AV, at least a portion of the sensor data, a description of a scene associated with the emergency event, a description of the AV, a description of one or more injuries of one or more passengers of the AV, a location of the AV, a description of one or more conditions detected within a period of time prior to the emergency event, and/or an indication of one or more hazards associated with at least one of the emergency event and a location of the AV.

At block 606, the process 600 can include, in response to detecting the emergency event, sending, to an emergency responder, a wireless signal comprising a request for help from the emergency responder and the information about the emergency event. In some examples, sending the information about the emergency event can include sending, to an emergency vehicle associated with the emergency responder, a vehicle-to-vehicle (V2V) wireless communication signal while the emergency vehicle is en route to a location of the AV. In some cases, the V2V wireless communication signal can include the information about the emergency event.

At block 608, the process 600 can include providing, based on a determination that the emergency responder is within a threshold proximity to the AV, additional data associated with the emergency event to the emergency responder and/or one or more devices associated with the emergency responder. In some cases, the one or more devices associated with the emergency responder can include a mobile phone, a tablet computer, a smart wearable device, a laptop computer, and/or a computer of a vehicle associated with the emergency responder.

In some cases, the additional data and/or the wireless signal can include an access code configured to enable the emergency responder to open one or more doors of the AV. In some aspects, the process 600 can include receiving an input comprising the access code; and in response to the input, unlocking the one or more doors of the AV. In some cases, the input can include a voice command, a touch input to a touch input surface of the AV, and/or a keyless entry code entered via a keypad on the AV, such as a keypad on a door of the AV, for example.

In some cases, the additional data and/or the information about the emergency event can include a speed of the AV prior to the emergency event, a direction of the AV prior to the emergency event, a speed of the AV at a time of impact of a collision comprising the emergency event, a description of a vehicle or object involved in the collision with the AV, a description of a scene associated with the emergency event, and/or a state of the AV.

In some aspects, the process 600 can include determining, in response to detecting the emergency event, respective safety risks of stopping the AV at one or more locations in a scene associated with the emergency event and, based on the respective safety risks, determining a location to stop the AV from the one or more locations in the scene. In some examples, the respective safety risks are determined based on estimated field-of-views (FOVs) of incoming vehicles relative to the one or more locations in the scene. In some cases, the location to stop the AV is selected based on a determination that the location is at least partially within an estimated FOV of incoming vehicles.

In some aspects, the process 600 can include moving the AV to the location within the scene, and outputting an alert warning other vehicles of the emergency event and/or a parked state of the AV. In some examples, the alert can include an audio alert, a video alert, an image alert, a text alert, a light emitted by a light-emitting device of the AV, and/or a pattern of light emitted by the light-emitting device.

In some aspects, the process 600 can include generating a prompt for additional information associated with the emergency event; receiving, from one or more passengers of the AV, speech including the additional information associated with the emergency event; and sending, to the emergency responder, the additional information. In some cases, the process 600 can include recognizing the speech using a speech recognition algorithm.

In some examples, the emergency event can include a health emergency of a passenger of the AV. In some aspects, the process 600 can include receiving, from a smart wearable device having one or more sensors, data indicating the health emergency of the passenger; and detecting the emergency event based on the data indicating the health emergency. In some examples, the smart wearable device can include a smart watch, a smart wristband or bracelet, a smart ring, a continuous glucose monitor, and/or smart glasses. In some cases, the one or more sensors of the smart wearable device can include an oximeter, a pulse or heart rate sensor, a glucose sensor, a temperature sensor, a blood pressure sensor, a metabolic rate sensor, an activity sensor, and/or any other health sensor.

In some examples, the additional data can include updated information about the emergency event, instructions on how to provide assistance to one or more passengers of the AV, a code that the emergency responder can use to access the AV, information about a scene of the emergency event, and/or an output message with information about the AV, one or more passengers of the AV, one or more injuries of one or more individuals involved in the emergency event, a type of help needed by one or more passengers of the AV, and/or a scene associated with the emergency event.

In some aspects, the process 600 can include determining, based on additional sensor data from the AV, that the emergency responder is within a threshold proximity to the AV. In some examples, the additional sensor data can include image data (e.g., video frames and/or still images) from one or more camera sensors of the AV, location data from one or more global positioning system (GPS) devices, data from one or more radio detection and ranging (RADAR) devices, data from one or more light detection and ranging (LIDAR) devices, and/or data from one or more inertial sensors.

In some examples, determining that the emergency responder is within the threshold proximity to the AV can include detecting audio alerts (e.g., sirens) generated by a device (e.g., a speaker or siren) associated with the emergency responder, detecting one or more lights associated with the emergency responder, detecting an emergency vehicle associated with the emergency responder, detecting one or more identifying marks (e.g., identifying letters/words, identifying symbol, identifying colors, identifying uniforms, identifying gear, identifying tools, etc.) on one or more objects and/or articles of clothing worn by one or more emergency responders, and/or detecting one or more visual and/or audio cues associated with the emergency responder.

FIG. 7 illustrates an example processor-based system with which some aspects of the subject technology can be implemented. For example, processor-based system 700 can be any computing device making up local computing device 110, client computing device 170, a passenger device executing the ridesharing application 172, or any component thereof in which the components of the system are in communication with each other using connection 705. Connection 705 can be a physical connection via a bus, or a direct connection into processor 710, such as in a chipset architecture. Connection 705 can also be a virtual connection, networked connection, or logical connection.

In some examples, computing system 700 is a distributed system in which the functions described in this disclosure can be distributed within a datacenter, multiple data centers, a peer network, etc. In some embodiments, one or more of the described system components represents many such components each performing some or all of the function for which the component is described. In some embodiments, the components can be physical or virtual devices.

Example system 700 includes at least one processing unit (CPU or processor) 710 and connection 705 that couples various system components including system memory 715, such as read-only memory (ROM) 720 and random-access memory (RAM) 725 to processor 710. Computing system 700 can include a cache of high-speed memory 712 connected directly with, in close proximity to, and/or integrated as part of processor 710.

Processor 710 can include any general-purpose processor and a hardware service or software service, such as services 732, 734, and 736 stored in storage device 730, configured to control processor 710 as well as a special-purpose processor where software instructions are incorporated into the actual processor design. Processor 710 may essentially be a completely self-contained computing system, containing multiple cores or processors, a bus, memory controller, cache, etc. A multi-core processor may be symmetric or asymmetric.

To enable user interaction, computing system 700 can include an input device 745, which can represent any number of input mechanisms, such as a microphone for speech, a touch-sensitive screen for gesture or graphical input, keyboard, mouse, motion input, speech, etc. Computing system 700 can also include output device 735, which can be one or more of a number of output mechanisms known to those of skill in the art. In some instances, multimodal systems can enable a user to provide multiple types of input/output to communicate with computing system 700. Computing system 700 can include communications interface 740, which can generally govern and manage the user input and system output. The communication interface may perform or facilitate receipt and/or transmission wired or wireless communications via wired and/or wireless transceivers, including those making use of an audio jack/plug, a microphone jack/plug, a universal serial bus (USB) port/plug, an Apple® Lightning® port/plug, an Ethernet port/plug, a fiber optic port/plug, a proprietary wired port/plug, a BLUETOOTH® wireless signal transfer, a BLUETOOTH® low energy (BLE) wireless signal transfer, an IBEACON® wireless signal transfer, a radio-frequency identification (RFID) wireless signal transfer, near-field communications (NFC) wireless signal transfer, dedicated short range communication (DSRC) wireless signal transfer, 802.11 Wi-Fi wireless signal transfer, wireless local area network (WLAN) signal transfer, Visible Light Communication (VLC), Worldwide Interoperability for Microwave Access (WiMAX), Infrared (IR) communication wireless signal transfer, Public Switched Telephone Network (PSTN) signal transfer, Integrated Services Digital Network (ISDN) signal transfer, 3G/4G/9G/LTE cellular data network wireless signal transfer, ad-hoc network signal transfer, radio wave signal transfer, microwave signal transfer, infrared signal transfer, visible light signal transfer, ultraviolet light signal transfer, wireless signal transfer along the electromagnetic spectrum, or some combination thereof.

Communications interface 740 may also include one or more Global Navigation Satellite System (GNSS) receivers or transceivers that are used to determine a location of the computing system 700 based on receipt of one or more signals from one or more satellites associated with one or more GNSS systems. GNSS systems include, but are not limited to, the US-based Global Positioning System (GPS), the Russia-based Global Navigation Satellite System (GLONASS), the China-based BeiDou Navigation Satellite System (BDS), and the Europe-based Galileo GNSS. There is no restriction on operating on any particular hardware arrangement, and therefore the basic features here may easily be substituted for improved hardware or firmware arrangements as they are developed.

Storage device 730 can be a non-volatile and/or non-transitory computer-readable memory device and can be a hard disk or other types of computer readable media which can store data that are accessible by a computer, such as magnetic cassettes, flash memory cards, solid state memory devices, digital versatile disks, cartridges, a floppy disk, a flexible disk, a hard disk, magnetic tape, a magnetic strip/stripe, any other magnetic storage medium, flash memory, memristor memory, any other solid-state memory, a compact disc read only memory (CD-ROM) optical disc, a rewritable compact disc (CD) optical disc, digital video disk (DVD) optical disc, a blu-ray disc (BDD) optical disc, a holographic optical disk, another optical medium, a secure digital (SD) card, a micro secure digital (microSD) card, a Memory Stick® card, a smartcard chip, a EMV chip, a subscriber identity module (SIM) card, a mini/micro/nano/pico SIM card, another integrated circuit (IC) chip/card, random access memory (RAM), static RAM (SRAM), dynamic RAM (DRAM), read-only memory (ROM), programmable read-only memory (PROM), erasable programmable read-only memory (EPROM), electrically erasable programmable read-only memory (EEPROM), flash EPROM (FLASHEPROM), cache memory (L1/L2/L3/L4/L9/L #), resistive random-access memory (RRAM/ReRAM), phase change memory (PCM), spin transfer torque RAM (STT-RAM), another memory chip or cartridge, and/or a combination thereof.

Storage device 730 can include software services, servers, services, etc., that when the code that defines such software is executed by the processor 710, causes the system to perform a function. In some examples, a hardware service that performs a particular function can include the software component stored in a computer-readable medium in connection with the necessary hardware components, such as processor 710, connection 705, output device 735, etc., to carry out the function.

As understood by those of skill in the art, machine-learning techniques can vary depending on the desired implementation. For example, machine-learning schemes can utilize one or more of the following, alone or in combination: hidden Markov models; recurrent neural networks; convolutional neural networks (CNNs); deep learning; Bayesian symbolic methods; general adversarial networks (GANs); support vector machines; image registration methods; applicable rule-based system. Where regression algorithms are used, they may include but are not limited to: a Stochastic Gradient Descent Regressor, and/or a Passive Aggressive Regressor, etc.

Machine learning classification models can also be based on clustering algorithms (e.g., a Mini-batch K-means clustering algorithm), a recommendation algorithm (e.g., a Miniwise Hashing algorithm, or Euclidean Locality-Sensitive Hashing (LSH) algorithm), and/or an anomaly detection algorithm, such as a Local outlier factor. Additionally, machine-learning models can employ a dimensionality reduction approach, such as, one or more of: a Mini-batch Dictionary Learning algorithm, an Incremental Principal Component Analysis (PCA) algorithm, a Latent Dirichlet Allocation algorithm, and/or a Mini-batch K-means algorithm, etc.

Aspects within the scope of the present disclosure may also include tangible and/or non-transitory computer-readable storage media or devices for carrying or having computer-executable instructions or data structures stored thereon. Such tangible computer-readable storage devices can be any available device that can be accessed by a general purpose or special purpose computer, including the functional design of any special purpose processor as described above. By way of example, and not limitation, such tangible computer-readable devices can include RAM, ROM, EEPROM, CD-ROM or other optical disk storage, magnetic disk storage or other magnetic storage devices, or any other device which can be used to carry or store desired program code in the form of computer-executable instructions, data structures, or processor chip design. When information or instructions are provided via a network or another communications connection (either hardwired, wireless, or combination thereof) to a computer, the computer properly views the connection as a computer-readable medium. Thus, any such connection is properly termed a computer-readable medium. Combinations of the above should also be included within the scope of the computer-readable storage devices.

Computer-executable instructions include, for example, instructions and data which cause a general-purpose computer, special-purpose computer, or special-purpose processing device to perform a certain function or group of functions. By way of example, computer-executable instructions can be used to implement perception system functionality for determining when sensor cleaning operations are needed or should begin. Computer-executable instructions can also include program modules that are executed by computers in stand-alone or network environments. Generally, program modules include routines, programs, components, data structures, objects, and the functions inherent in the design of special-purpose processors, etc. that perform tasks or implement abstract data types. Computer-executable instructions, associated data structures, and program modules represent examples of the program code means for executing steps of the methods disclosed herein. The particular sequence of such executable instructions or associated data structures represents examples of corresponding acts for implementing the functions described in such steps.

Other examples of the disclosure may be practiced in network computing environments with many types of computer system configurations, including personal computers, hand-held devices, multi-processor systems, microprocessor-based or programmable consumer electronics, network PCs, minicomputers, mainframe computers, and the like. Aspects of the disclosure may also be practiced in distributed computing environments where tasks are performed by local and remote processing devices that are linked (either by hardwired links, wireless links, or by a combination thereof) through a communications network. In a distributed computing environment, program modules can be located in both local and remote memory storage devices.

The various examples described above are provided by way of illustration only and should not be construed to limit the scope of the disclosure. For example, the principles herein apply equally to optimization as well as general improvements. Various modifications and changes may be made to the principles described herein without following the example aspects and applications illustrated and described herein, and without departing from the spirit and scope of the disclosure.

Claim language or other language in the disclosure reciting “at least one of” a set and/or “one or more” of a set indicates that one member of the set or multiple members of the set (in any combination) satisfy the claim. For example, claim language reciting “at least one of A and B” or “at least one of A or B” means A, B, or A and B. In another example, claim language reciting “at least one of A, B, and C” or “at least one of A, B, or C” means A, B, C, or A and B, or A and C, or B and C, or A and B and C. The language “at least one of” a set and/or “one or more” of a set does not limit the set to the items listed in the set. For example, claim language reciting “at least one of A and B” or “at least one of A or B” can mean A, B, or A and B, and can additionally include items not listed in the set of A and B.

Illustrative examples of the disclosure include:

Aspect 1. A system comprising: a memory; and one or more processors coupled to the memory, the one or more processors being configured to: detect, based on sensor data captured by an autonomous vehicle (AV), an emergency event associated with the AV; in response to detecting the emergency event: generate information about the emergency event based on the sensor data; and send, to an emergency responder, a wireless signal comprising a request for help from the emergency responder and the information about the emergency event; and based on a determination that the emergency responder is within a threshold proximity to the AV, provide additional data associated with the emergency event to the emergency responder and/or one or more devices associated with the emergency responder.

Aspect 2. The system of Aspect 1, wherein the additional data and/or the information about the emergency event comprises at least one of a description of the emergency event, an indication of a number of passengers of the AV, an identity of one or more passengers of the AV, at least a portion of the sensor data, a description of a scene associated with the emergency event, a description of the AV, a description of one or more injuries of one or more passengers of the AV, a location of the AV, a description of one or more conditions detected within a period of time prior to the emergency event, and an indication of one or more hazards associated with at least one of the emergency event and a location of the AV.

Aspect 3. The system of Aspect 1 or 2, wherein sending the information about the emergency event comprises sending, to an emergency vehicle associated with the emergency responder, a vehicle-to-vehicle (V2V) wireless communication signal while the emergency vehicle is en route to a location of the AV, the V2V wireless communication signal comprising the information about the emergency event.

Aspect 4. The system of any of Aspects 1 to 3, wherein the additional data and/or the wireless signal further comprises an access code configured to enable the emergency responder to open one or more doors of the AV.

Aspect 5. The system of Aspect 4, wherein the one or more processors are configured to: receive an input comprising the access code; and in response to the input, unlock the one or more doors of the AV.

Aspect 6. The system of Aspect 5, wherein the input comprises at least one of a voice command, a touch input to a touch input surface on the AV, and a keyless entry code entered via a keypad on the AV.

Aspect 7. The system of any of Aspects 1 to 6, wherein the additional data and/or the information about the emergency event comprises at least one of a speed of the AV prior to the emergency event, a direction of the AV prior to the emergency event, a speed of the AV at a time of impact of a collision comprising the emergency event, a description of a vehicle or object involved in the collision with the AV, a description of a scene associated with the emergency event, and a state of the AV.

Aspect 8. The system of any of Aspects 1 to 7, wherein the one or more processors are configured to: in response to detecting the emergency event, determine respective safety risks of stopping the AV at one or more locations in a scene associated with the emergency event; and based on the respective safety risks, determine a location to stop the AV from the one or more locations in the scene.

Aspect 9. The system of Aspect 8, wherein the respective safety risks are determined based on estimated field-of-views (FOVs) of incoming vehicles relative to the one or more locations in the scene, wherein the location to stop the AV is selected based on a determination that the location is at least partially within an estimated FOV of incoming vehicles.

Aspect 10. The system of any of Aspects 8 to 9, wherein the one or more processors are configured to: move the AV to the location within the scene; and output an alert warning other vehicles of at least one of the emergency event and a parked state of the AV, wherein the alert comprises at least one of an audio alert, a video alert, an image alert, a text alert, a light emitted by a light-emitting device of the AV, and a pattern of light emitted by the light-emitting device.

Aspect 11. The system of any of Aspects 1 to 10, wherein the additional data comprises updated information about the emergency event, instructions on how to provide assistance to one or more passengers of the AV, a code that the emergency responder can use to access the AV, information about a scene of the emergency event, and an output message with information about at least one of the AV, one or more passengers of the AV, one or more injuries of one or more individuals involved in the emergency event, a type of help needed by one or more passengers of the AV, and/or a scene associated with the emergency event.

Aspect 12. The system of any of Aspects 1 to 11, wherein the one or more devices associated with the emergency responder comprise a mobile phone, a tablet computer, a smart wearable device, a laptop computer, and a computer of a vehicle associated with the emergency responder.

Aspect 13. The system of any of Aspects 1 to 12, wherein the one or more processors are configured to determine, based on additional sensor data from the AV, that the emergency responder is within a threshold proximity to the AV, wherein the additional sensor data comprises image data from one or more camera sensors of the AV, location data from one or more global positioning system (GPS) devices, data from one or more radio detection and ranging (RADAR) devices, data from one or more light detection and ranging (LIDAR) devices, and/or data from one or more inertial sensors.

Aspect 14. The system of Aspect 13, wherein the determining that the emergency responder is within the threshold proximity to the AV comprises detecting audio alerts (e.g., sirens) generated by a device associated with the emergency responder, detecting one or more lights associated with the emergency responder, detecting an emergency vehicle associated with the emergency responder, detecting one or more identifying marks on one or more objects and/or articles of clothing worn by one or more emergency responders, and/or detecting one or more visual and/or audio cues associated with the emergency responder.

Aspect 15. A method comprising: detecting, based on sensor data captured by an autonomous vehicle (AV), an emergency event associated with the AV; in response to detecting the emergency event: generating information about the emergency event based on the sensor data; and sending, to an emergency responder, a wireless signal including a request for help from the emergency responder and the information about the emergency event; and based on a determination that the emergency responder is within a threshold proximity to the AV, provide additional data associated with the emergency event to at least one of the emergency responder and one or more devices associated with the emergency responder.

Aspect 16. The method of Aspect 15, wherein the additional data and/or the information about the emergency event comprises at least one of a description of the emergency event, an indication of a number of passengers of the AV, an identity of one or more passengers of the AV, at least a portion of the sensor data, a description of a scene associated with the emergency event, a description of the AV, a description of one or more injuries of one or more passengers of the AV, a location of the AV, a description of one or more conditions detected within a period of time prior to the emergency event, and an indication of one or more hazards associated with at least one of the emergency event and a location of the AV.

Aspect 17. The method of Aspect 15 or 16, wherein sending the information about the emergency event comprises sending, to an emergency vehicle associated with the emergency responder, a vehicle-to-vehicle (V2V) wireless communication signal while the emergency vehicle is en route to a location of the AV, the V2V wireless communication signal comprising the information about the emergency event.

Aspect 18. The method of any of Aspects 15 to 17, wherein the additional data and/or the wireless signal further comprises an access code configured to enable the emergency responder to open one or more doors of the AV.

Aspect 19. The method of Aspect 18, further comprising: receive an input comprising the access code; and in response to the input, unlock the one or more doors of the AV.

Aspect 20. The method of Aspect 19, wherein the input comprises at least one of a voice command, a touch input provided via a touch input surface of the AV, and a keyless entry code entered via a keypad on the AV.

Aspect 21. The method of any of Aspects 19 to 20, wherein the additional data and/or the information about the emergency event comprises at least one of a speed of the AV prior to the emergency event, a direction of the AV prior to the emergency event, a speed of the AV at a time of impact of a collision comprising the emergency event, a description of a vehicle or object involved in the collision with the AV, a description of a scene associated with the emergency event, and a state of the AV.

Aspect 22. The method of any of Aspects 15 to 21, further comprising: in response to detecting the emergency event, determining respective safety risks of stopping the AV at one or more locations in a scene associated with the emergency event; and based on the respective safety risks, determining a location to stop the AV from the one or more locations in the scene.

Aspect 23. The method of Aspect 22, wherein the respective safety risks are determined based on estimated field-of-views (FOVs) of incoming vehicles relative to the one or more locations in the scene, wherein the location to stop the AV is selected based on a determination that the location is at least partially within an estimated FOV of incoming vehicles.

Aspect 24. The method of any of Aspects 22 or 23, further comprising: moving the AV to the location within the scene; and outputting an alert warning other vehicles of at least one of the emergency event and a parked state of the AV, wherein the alert comprises at least one of an audio alert, a video alert, an image alert, a text alert, a light emitted by a light-emitting device of the AV, and a pattern of light emitted by the light-emitting device.

Aspect 25. The method of any of Aspects 15 to 24, further comprising: generating a prompt for additional information associated with the emergency event; receiving, from one or more passengers of the AV, speech comprising the additional information associated with the emergency event; and sending, to the emergency responder, the additional information.

Aspect 26. The method of any of Aspects 15 to 25, wherein the additional data comprises updated information about the emergency event, instructions on how to provide assistance to one or more passengers of the AV, a code that the emergency responder can use to access the AV, information about a scene of the emergency event, and an output message with information about at least one of the AV, one or more passengers of the AV, one or more injuries of one or more individuals involved in the emergency event, a type of help needed by one or more passengers of the AV, and/or a scene associated with the emergency event.

Aspect 27. The method of any of Aspects 15 to 26, wherein the one or more devices associated with the emergency responder comprise a mobile phone, a tablet computer, a smart wearable device, a laptop computer, and a computer of a vehicle associated with the emergency responder.

Aspect 28. The method of any of Aspects 15 to 27, wherein the one or more processors are configured to determine, based on additional sensor data from the AV, that the emergency responder is within a threshold proximity to the AV, wherein the additional sensor data comprises image data from one or more camera sensors of the AV, location data from one or more global positioning system (GPS) devices, data from one or more radio detection and ranging (RADAR) devices, data from one or more light detection and ranging (LIDAR) devices, and/or data from one or more inertial sensors.

Aspect 29. The method of Aspect 28, wherein the determining that the emergency responder is within the threshold proximity to the AV comprises detecting audio alerts (e.g., sirens) generated by a device associated with the emergency responder, detecting one or more lights associated with the emergency responder, detecting an emergency vehicle associated with the emergency responder, detecting one or more identifying marks on one or more objects and/or articles of clothing worn by one or more emergency responders, and/or detecting one or more visual and/or audio cues associated with the emergency responder.

Aspect 30. An autonomous vehicle comprising: a memory and one or more processors coupled to the memory, the one or more processors being configured to perform a method according to any of Aspects 15 to 29.

Aspect 31. A non-transitory computer-readable medium having stored thereon instructions which, when executed by one or more processors, cause the one or more processors to perform a method according to any of Aspects 15 to 29.

Aspect 32. A system comprising means for performing a method according to any of Aspects 15 to 29.

What is claimed is:

1. A system comprising:
a memory; and
one or more processors coupled to the memory, the one or more processors being configured to:
detect, based on sensor data captured by an autonomous vehicle (AV), an emergency event associated with the AV;
in response to detecting the emergency event:
generate information about the emergency event based on the sensor data; and
send, to an emergency responder, a wireless signal comprising a request for help from the emergency responder and the information about the emergency event; and
based on a determination that the emergency responder is within a threshold proximity to the AV, provide additional data associated with the emergency event to at least one of the emergency responder and one or more devices associated with the emergency responder.

2. The system of claim 1, wherein the at least one of the information about the emergency event and the additional data comprises at least one of a description of the emergency event, an indication of a number of passengers of the AV, an identity of one or more passengers of the AV, at least a portion of the sensor data, a description of a scene associated with the emergency event, a description of the AV, a description of one or more injuries of one or more passengers of the AV, a location of the AV, a description of one or more conditions detected within a period of time prior to the emergency event, and an indication of one or more hazards associated with at least one of the emergency event and a location of the AV.

3. The system of claim 1, wherein sending the information about the emergency event comprises sending, to an emergency vehicle associated with the emergency responder, a vehicle-to-vehicle (V2V) wireless communication signal while the emergency vehicle is en route to a location of the AV, the V2V wireless communication signal comprising the information about the emergency event.

4. The system of claim 1, wherein at least one of the additional data and the wireless signal further comprises an access code configured to enable the emergency responder to open one or more doors of the AV.

5. The system of claim 4, wherein the one or more processors are configured to:
receive an input comprising the access code; and
in response to the input, unlock the one or more doors of the AV, wherein the input comprises at least one of a voice command, a touch input provided via a touch input surface on the AV, and a keyless entry code entered via a keypad on the AV.

6. The system of claim 1, wherein the additional data comprises at least one of updated information about the emergency event, instructions on how to provide assistance to one or more passengers of the AV, a code that the emergency responder can use to access the AV, information about a scene of the emergency event, and an output message with information about at least one of the AV, one or more passengers of the AV, one or more injuries of one or more individuals involved in the emergency event, a type of help needed by one or more passengers of the AV, and a scene associated with the emergency event.

7. The system of claim 1, wherein at least one of the additional data and the information about the emergency event comprises at least one of a speed of the AV prior to the emergency event, a direction of the AV prior to the emergency event, a speed of the AV at a time of impact of a collision associated with the emergency event, a description of a vehicle or object involved in the collision with the AV, a description of a scene associated with the emergency event, and a state of the AV.

8. The system of claim 1, wherein the one or more processors are configured to:
in response to detecting the emergency event, determine respective safety risks of stopping the AV at one or more locations in a scene associated with the emergency event; and
based on the respective safety risks, determine a location to stop the AV from the one or more locations in the scene.

9. The system of claim 8, wherein the respective safety risks are determined based on estimated field-of-views (FOVs) of incoming vehicles relative to the one or more locations in the scene, wherein the location to stop the AV is selected based on a determination that the location is at least partially within an estimated FOV of incoming vehicles.

10. The system of claim 8, wherein the one or more processors are configured to:
move the AV to the location within the scene; and
output an alert warning other vehicles of at least one of the emergency event and a parked state of the AV, wherein the alert comprises at least one of an audio alert, a video alert, an image alert, a text alert, a light emitted by a light-emitting device of the AV, and a pattern of light emitted by the light-emitting device.

11. A method comprising:
detecting, based on sensor data captured by an autonomous vehicle (AV), an emergency event associated with the AV;
in response to detecting the emergency event:
generating information about the emergency event based on the sensor data; and
sending, to an emergency responder, a wireless signal comprising a request for help from the emergency responder and the information about the emergency event; and
based on a determination that the emergency responder is within a threshold proximity to the AV, providing additional data associated with the emergency event to at least one of the emergency responder and one or more devices associated with the emergency responder.

12. The method of claim 11, wherein at least one of the additional data and the information about the emergency event comprises at least one of a description of the emergency event, an indication of a number of passengers of the AV, an identity of one or more passengers of the AV, at least a portion of the sensor data, a description of a scene associated with the emergency event, a description of the AV, a description of one or more injuries of one or more passengers of the AV, a location of the AV, a description of one or more conditions detected within a period of time prior to the emergency event, and an indication of one or more hazards associated with at least one of the emergency event and a location of the AV.

13. The method of claim 11, wherein sending the information about the emergency event comprises sending, to an emergency vehicle associated with the emergency responder, a vehicle-to-vehicle (V2V) wireless communication signal while the emergency vehicle is en route to a location of the AV, the V2V wireless communication signal comprising the information about the emergency event.

14. The method of claim 11, wherein at least one of the additional data and the wireless signal further comprises an access code configured to enable the emergency responder to open one or more doors of the AV, the method further comprising:
receiving an input comprising the access code; and
in response to the input, unlocking the one or more doors of the AV, wherein the input comprises at least one of a voice command, a touch input to a touch input surface of the AV, and a keyless entry code entered via a keypad on the AV.

15. The method of claim 11, wherein the additional data comprises at least one of updated information about the emergency event, instructions on how to provide assistance to one or more passengers of the AV, a code that the emergency responder can use to access the AV, information about a scene of the emergency event, and an output message with information about at least one of the AV, one or more passengers of the AV, one or more injuries of one or more individuals involved in the emergency event, a type of help needed by one or more passengers of the AV, and a scene associated with the emergency event.

16. The method of claim 11, wherein at least one of the additional data and the information about the emergency event comprises at least one of a speed of the AV prior to the emergency event, a direction of the AV prior to the emergency event, a speed of the AV at a time of impact of a collision comprising the emergency event, a description of a vehicle or object involved in the collision with the AV, a description of a scene associated with the emergency event, and a state of the AV.

17. The method of claim 11, further comprising:
in response to detecting the emergency event, determining respective safety risks of stopping the AV at one or more locations in a scene associated with the emergency event; and
based on the respective safety risks, determining a location to stop the AV from the one or more locations in the scene.

18. The method of claim 17, wherein the respective safety risks are determined based on estimated field-of-views (FOVs) of incoming vehicles relative to the one or more locations in the scene, wherein the location to stop the AV is selected based on a determination that the location is at least partially within an estimated FOV of incoming vehicles.

19. The method of claim 17, further comprising:
moving the AV to the location within the scene; and
outputting an alert warning other vehicles of at least one of the emergency event and a parked state of the AV, wherein the alert comprises at least one of an audio alert, a video alert, an image alert, a text alert, a light emitted by a light-emitting device of the AV, and a pattern of light emitted by the light-emitting device.

20. A non-transitory computer-readable medium having stored thereon instructions which, when executed by one or more processors, cause the one or more processors to:
detect, based on sensor data captured by an autonomous vehicle (AV), an emergency event associated with the AV;
in response to detecting the emergency event:
generate information about the emergency event based on the sensor data; and
send, to an emergency responder, a wireless signal comprising a request for help from the emergency responder and the information about the emergency event; and
based on a determination that the emergency responder is within a threshold proximity to the AV, provide additional data associated with the emergency event to at least one of the emergency responder and one or more devices associated with the emergency responder.
